(19) United States
(12) Patent Application Publication
(10) Pub. No.: US 2019/0212901 A1
(43) Pub. Date: Jul. 11, 2019

(54) MANIPULATION OF CONTENT ON DISPLAY SURFACES VIA AUGMENTED REALITY

(71) Applicant: Cisco Technology, Inc., San Jose, CA (US)

(72) Inventors: Daniel Garrison, San Jose, CA (US); Joseph E. Sutton, Toledo, WA (US); Michael Hart, San Jose, CA (US); Ali Ebtekar, Palo Alto, CA (US); Brian Sarbin, Santa Clara, CA (US)

(21) Appl. No.: 15/986,572

(22) Filed: May 22, 2018

Related U.S. Application Data
(60) Provisional application No. 62/614,508, filed on Jan. 8, 2018.

(51) Int. Cl. G06F 3/0484; G06F 3/14; G06F 3/0482; G06F 3/0488

(52) U.S. Cl. CPC G06F 3/04845; G06F 3/1454; G06F 3/0488; G06F 3/0482; G06F 3/04842

(57) ABSTRACT

In one embodiment, a system comprising camera(s) adapted to capture first image(s) including display surface(s), touchscreen(s) adapted to detect user input, and processor(s) adapted to display, simultaneously on the touchscreen(s), an augmented reality user interface including the first image(s), and other item(s) not captured by the camera(s), the other item(s) including at least one of: control item(s), or content item(s), interpret the user input detected by the touchscreen(s) to include selection of a first item in the first image(s), and a second content item, determine that the first item is a first display surface of the display surface(s) in the first image(s), and cause the second content item to be moved to, or duplicated to, or moved from, or duplicated from, the first display surface.

### CROSS REFERENCE TO RELATED APPLICATIONS

This application claims priority to U.S. Provisional Patent Application No. 62/614,508, filed on Jan. 8, 2018, entitled “Manipulation Of Content On Display Surfaces Via Augmented Reality,” the content of which is incorporated herein by reference in its entirety.

### TECHNICAL FIELD

The present disclosure generally relates to augmented reality.

### BACKGROUND

In physical environments such as corporate meeting spaces, operational control rooms, and even various rooms in a home, there may be a number of display surfaces on which content may be displayed. Such display surfaces may be completely independent and of one or more different types, including for instance, telepresence units, televisions, monitors, and/or projection surfaces. It may be an inefficient, frustrating, and a time-consuming experience to deal with content across multiple, fragmented display surfaces in such a physical environment.

### BRIEF DESCRIPTION OF THE DRAWINGS

So that the present disclosure may be understood by those of ordinary skill in the art, a more detailed description may be had by reference to aspects of some illustrative implementations, some of which are shown in the accompanying drawings. The appended drawings, however, illustrate only some example features of the present disclosure and are therefore not to be considered limiting, for the description may admit to other effective features.

FIG. 1 illustrates a physical environment, in accordance with some embodiments of the presently disclosed subject matter;

FIG. 2 is a flowchart of a method, in accordance with some embodiments of the presently disclosed subject matter;

FIG. 3 illustrates a virtual spatial representation, in accordance with some embodiments of the presently disclosed subject matter;

FIG. 4 illustrates raycasting with reference to the virtual spatial representation of FIG. 3, in accordance with some embodiments of the presently disclosed subject matter;

FIGS. 5 to 9 illustrate the duplication of content displayed on a touchscreen of a portable computer, to a particular display surface, in accordance with some embodiments of the presently disclosed subject matter;

FIGS. 10 to 14 illustrate the moving of content displayed on a particular display surface, to other display surfaces, in accordance with some embodiments of the presently disclosed subject matter;

FIGS. 15 and 16 illustrate the duplication of content displayed on a particular display surface, to a touchscreen of a portable computer, in accordance with some embodiments of the presently disclosed subject matter;

FIGS. 17 to 19 illustrate a toggling of data layers of content, in accordance with some embodiments of the presently disclosed subject matter;

FIGS. 20 to 22 illustrate template selections, in accordance with some embodiments of the presently disclosed subject matters;

FIG. 23 illustrates establishment of an origin point, in accordance with some embodiments of the presently disclosed subject matter;

FIG. 24 illustrates the scanning of a physical environment, in accordance with some embodiments of the presently disclosed subject matter; and

FIG. 25 is a block diagram of a system, in accordance with some embodiments of the presently disclosed subject matter.

In accordance with common practice the various features illustrated in the drawings may not be drawn to scale. Accordingly, the dimensions of the various features may be arbitrarily expanded or reduced for clarity. In addition, some of the drawings may not depict all of the elements, items, stages, etc. of a given physical environment, system, user interface, method, etc.

### DESCRIPTION OF EXAMPLE EMBODIMENTS

### Overview

There is provided, in accordance with some embodiments of the presently disclosed subject matter a system comprising at least one camera adapted to capture at least one first image including one or more display surfaces, at least one touchscreen adapted to detect user input, and at least one processor adapted to display, simultaneously on the at least one touchscreen, an augmented reality user interface including the at least one first image, and at least one other item not captured by the at least one camera, the at least one other item including at least one of: one or more control items, or one or more content items, interpret the user input detected by the at least one touchscreen to include selection of a first item in the at least one first image, and a second content item, determine that the first item is a first display surface of the one or more display surfaces in the at least one first image, and cause the second content item to be moved to, or duplicated to, or moved from, or duplicated from, the first display surface.

### DETAILED DESCRIPTION OF EXAMPLE EMBODIMENTS

Some embodiments of the subject matter may use an augmented reality user interface or a template user interface, to manipulate the layout of content across display surfaces and/or a touchscreen in a physical environment. Additionally or alternatively, the augmented reality user interface may be used for non-layout manipulation of content, as will be described in more detail below. The term augmented reality, as used herein, should be understood to also encompass technology (e.g. mixed reality) which includes augmented reality in combination with other aspect(s) (e.g. virtual reality).

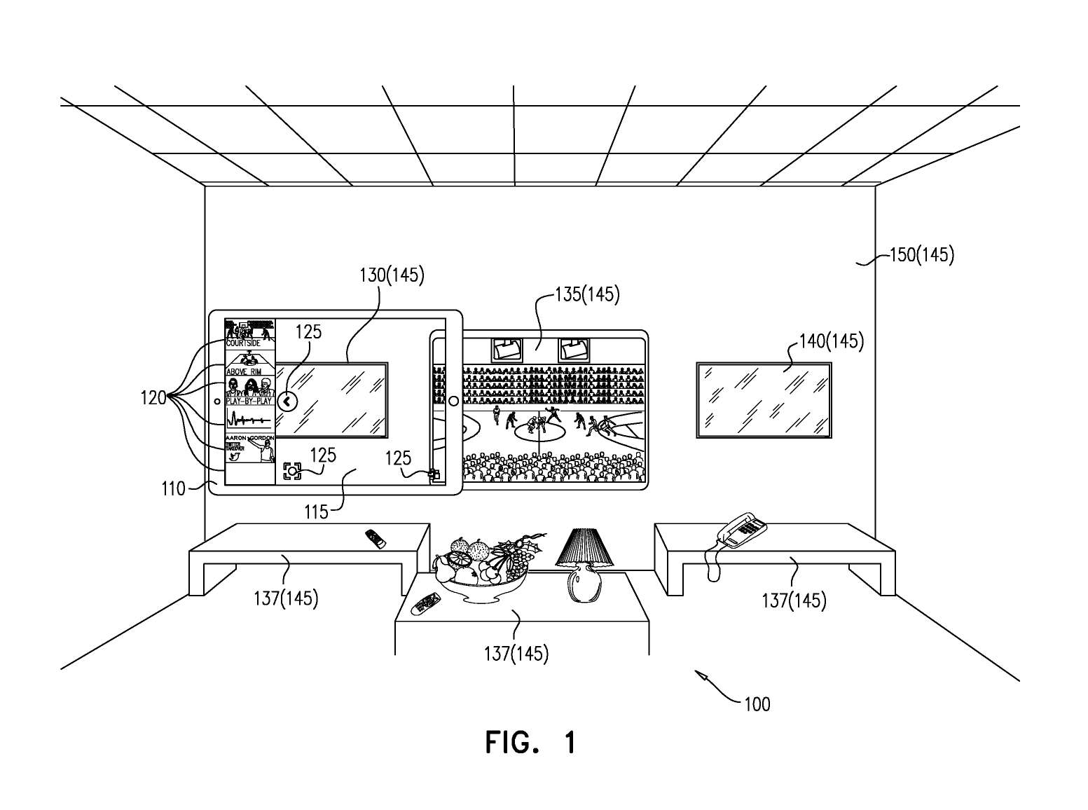

FIG. 1 illustrates a physical environment 100, in accordance with some embodiments of the presently disclosed subject matter.

Physical environment 100 includes display surfaces 145 and a portable computer 110. For example, display surfaces 145 may include:
televisions, monitors and/or telepresence units such as display surfaces 130, 135, and 140;
back wall 150, any of tables 137, the floor (not labeled), the ceiling (not labeled), any of the other walls (not shown), and/or any other appropriate projection surfaces upon which content may be displayed, e.g. due to commercially available projectors projecting the content;
any other appropriate display surfaces;
any part(s) of any of the above;
or a combination of any of the above.

Portable computer 110 may be a tablet computer, such as an iPad, a smartphone, a laptop, or any other suitable portable (i.e. mobile) computer. The term computer, as used herein, refers to any element that includes at least one processor, whether the element is portable or not. Portable computer 110 includes a camera (not shown) adapted to capture image(s), and a touchscreen 115 adapted to detect user input. The term user input, as used herein, may include any appropriate user gesture(s), such as one or more swipes (also referred to as slide(s)), one or more taps, one or more double-taps, one or more long-presses, one or more pinches, one or more reverse-pinches, one or more drag-and-drops, one or more drop-down menu selections, and/or one or more keyed inputs (e.g. via touchscreen keyboard).

Displayed on touchscreen 115 in FIG. 1 is an augmented reality user interface. The augmented reality user interface includes an image captured by the camera, as well as other one or more items not captured by the camera such as one or more content items 120 and/or one or more control items 125. For example, control item(s) 125 may be contextual, that is context sensitive. Context-sensitive control(s), for instance may vary depending on content, depending on display surface characteristics, etc. In some embodiments, control item(s) 125 may be divided into two primary types: placement control(s), relating to layout of content (e.g. relating to deleting, moving, resizing, and/or duplicating content items on display surfaces 145 and/or on touchscreen 115), and content control(s).

The image displayed on touchscreen 115 includes, inter-alia, display surfaces 130 and 135. Display surface 130 is completely included in the image, whereas display surface 135 is only partially included in the image. A particular content item may be displayed on touchscreen 115, e.g. due to the camera capturing in the image a display surface (e.g. 135) displaying the particular content item, or due to the particular content item being one of content items 120 not captured by the camera that are displayed on touchscreen 115. Touchscreen 115 may detect user input, the user input being indicative, for instance, of the particular content item, and of a particular display surface 145 (e.g. display surface 130 or 135) included in the image. Alternatively for example, the particular display surface 145 indicated by the user input may comprise any of the following:
display surface 130 and display surface 135 (entirely or the part in the image);
wall 150 (entirely or the part in the image);
wall 150 (entirely or the part in the image), and also display surface 130 and/or display surface 135 (entirely or the part in the image);
display surface 130 (entirely or partially), wall 150 (entirely or partially) and/or display surface 135 (entirely or partially);
etc.

Subsequent to the detection of the user input, the particular content item may be manipulated, for example, by moving or duplicating the particular content item, that may be one of content item(s) 120, to the particular display surface 145 or vice versa; by moving or duplicating the particular content item displayed on the particular display surface 145 to another display surface 145; by moving or duplicating the particular content item displayed on another display surface 145 to the particular display surface 145; and/or by any other content manipulation(s) that will be described in more detail below.

It will be appreciated that physical environment 100 may vary, depending on the embodiment, and may not necessarily be as depicted in FIG. 1.

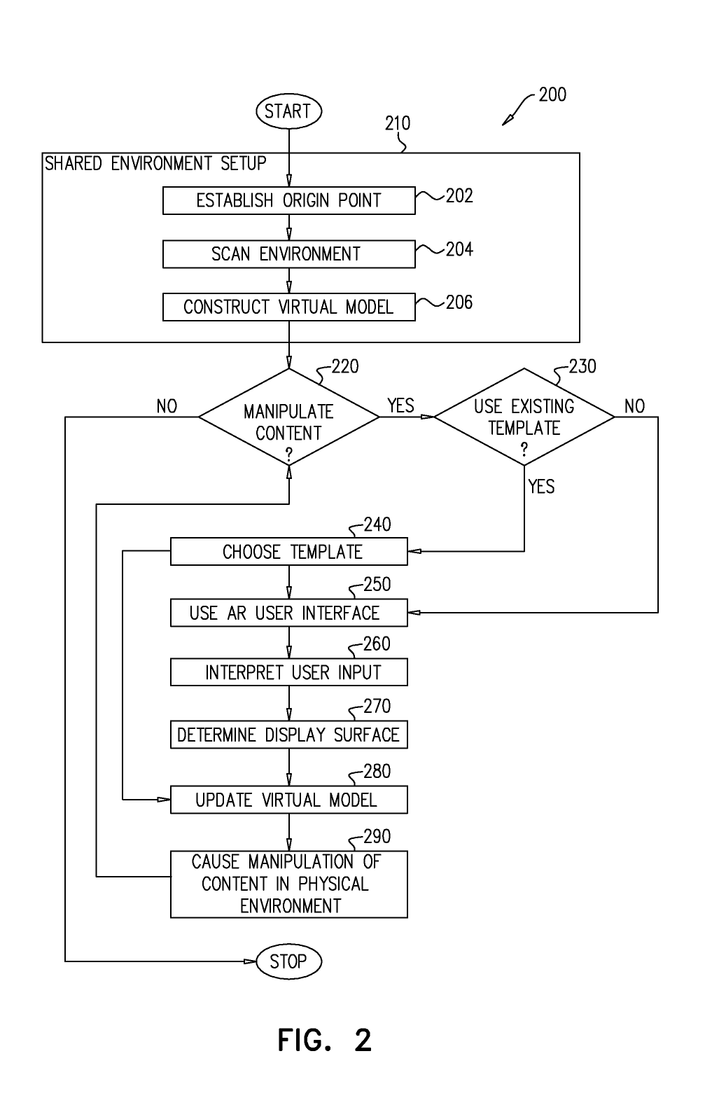

FIG. 2 illustrates a method 200, in accordance with some embodiments of the presently disclosed subject matter.

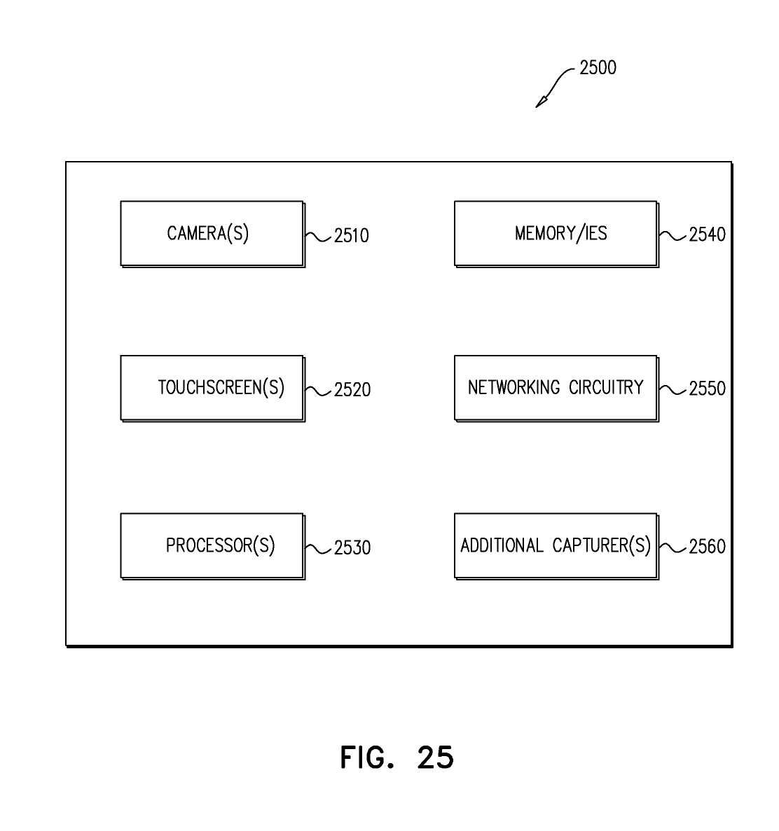

In stage 210, a shared environment state is set up, where the shared environment state includes a virtual model of physical environment 100 and origin point information. The virtual model may include a virtual camera. Possible embodiments of stage 210 will be discussed further below. However, for the sake of the current discussion, it is assumed that a virtual model is available for the remaining stages of method 200, so that a system which performs the remainder of method 200 may use the virtual model. Such a system may include touchscreen 115 of portable computer 110, a camera of portable computer 110 and additional elements. Possible elements of such a system will be discussed in more detail below with reference to FIG. 25.

In stage 220, it is determined whether or not to manipulate content on one or more display surfaces 145 and/or on touchscreen 115 (FIG. 1). For example, the determination may be based on whether or not user input has been detected by touchscreen 115 in portable computer 110 (FIG. 1), and/or based on an interpretation of user input detected by touchscreen 115 in portable computer 110. If it is determined not to manipulate the content, then method 200 stops or waits for further user input. If it is determined to manipulate content, then in optional stage 230, it is determined whether or not to use existing templates for manipulating the content. For example, the determination may be based on an interpretation of the user input. If it is determined to use existing templates, then in stage 240, a list of templates may be exposed for selection, and user input may be interpreted to include selection of one of the templates in the list. By allowing the user to provide user input that may be interpreted to include a selection of an existing template, a mechanism may be provided for the user to choose from pre-defined templates of content configurations, which lay out (or in other words, which position) content in physical environment 100, based on an awareness of physical environment 100. Templates will be discussed in more detail further below. In some embodiments, there may not be existing templates, and in such embodiments, stages 230 and 240 may be omitted. If it is determined not to use existing templates, or if stage 230 is omitted then in stage 250, the augmented reality user interface is used. In stage 260, the user input is interpreted to include selection of a content item, and of an item in an image captured by the camera. By allowing for the user to provide user input that may be interpreted to include selection of the content item and the item in the image, a mechanism may be provided for the user to select the content item, and the item (e.g. a particular display surface 145) in physical environment 100, using the augmented reality user interface.

For example, the augmented reality user interface may provide an association, via the image, to display surfaces 145 physically in physical environment 100 which may be displaying content items, and the augmented reality user interface may further provide control items 125 (e.g. contextual) and/or content items 120, allowing the user to seemingly “touch” a content item at any distance and cause manipulation of the content item. The interpretation (e.g. in real-time) of the user input may be achieved using the previously constructed virtual model.

As mentioned above, the user input is interpreted in stage 260 to include selection of an item in the image. In stage 270, it is determined that the selected item is a particular display surface 145 of the one or more display surfaces 145 in the image. That is, the two dimensional representation of the particular display surface 145 is captured in the image displayed on touchscreen 115 of portable computer 110 and the three dimensional physical entity of the particular display surface 145 exists in physical environment 100. For example, the particular display surface 145 that is being selected may be determined based on the position on the touchscreen that is touched during the user input. When the user touches a position on touchscreen 115 of portable computer 110, it may be determined, using a virtual model of physical environment 100, if the user “touched” a particular display surface 145 physically in physical environment 100. Such a determination may be made in the virtual model via a process called raycasting, where the ray is representative of user input, or via any other appropriate process. With raycasting, a ray is sent from a virtual camera in the virtual model in the direction specified by the touch position. If the ray intersects with an object (e.g. a virtual display surface) in the virtual model, it may be concluded that the user has “touched” the object, and based on the type of user input, the appropriate manipulation of the content item may be performed, as will be explained in more detail below with reference to stage 290.

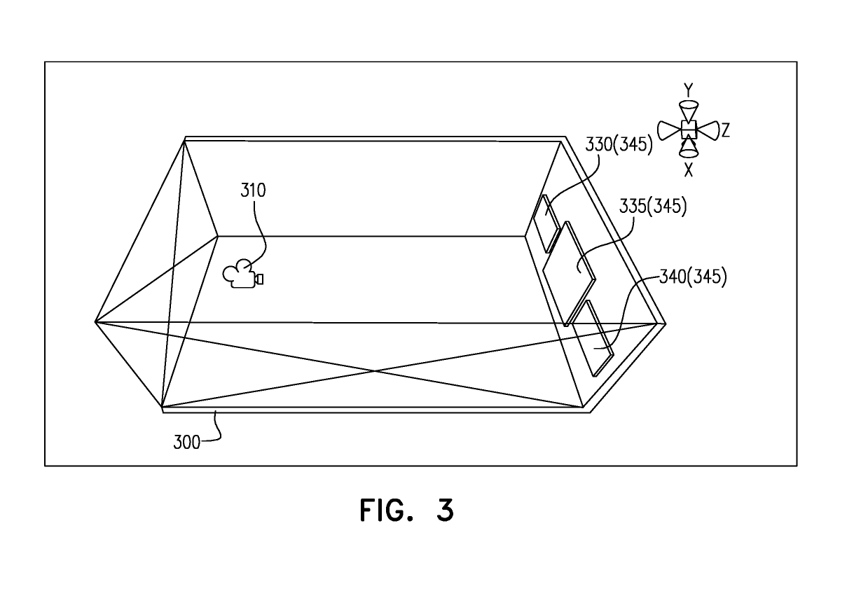

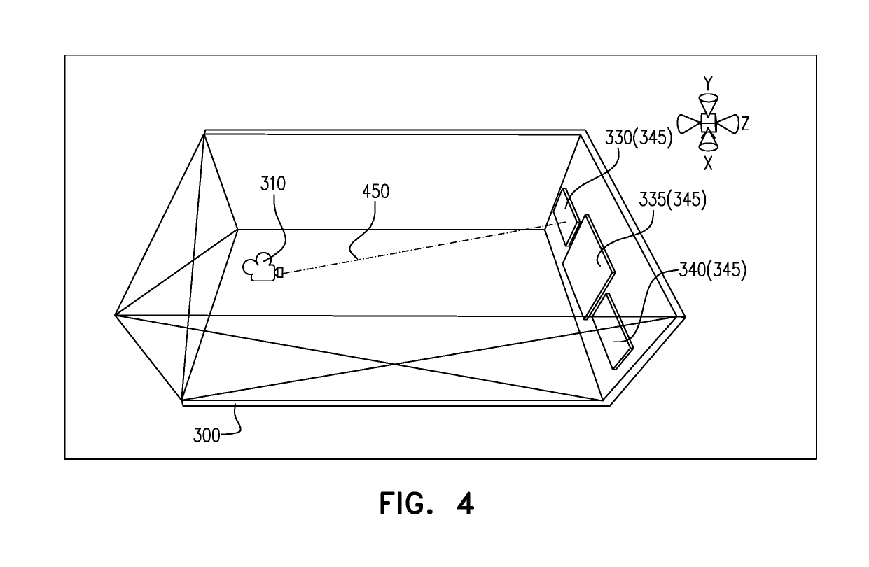

An example of raycasting will now be discussed with reference to FIGS. 3 and 4 and with reference to a virtual spatial representation included in a virtual model of physical environment 100 (FIG. 1).

Referring to FIG. 3, FIG. 3 illustrates a virtual spatial representation 300, in accordance with some embodiments of the presently disclosed subject matter.

Virtual spatial representation 300 is included in a virtual model of physical environment 100 (FIG. 1). Virtual spatial representation 300 comprises a virtual camera 310, and virtual display surfaces 345 (e.g. including virtual display surfaces 330, 335, and 340). The virtual camera is a virtual representation of a camera in portable computer 110 (FIG. 1). The virtual display surfaces are respective virtual representations of display surfaces 130, 135, and 140 (FIG. 1). For simplicity's sake, virtual representations of other display surfaces 145 of physical environment 100, are not shown/labeled in virtual spatial representation 300. Referring now to FIG. 4, FIG. 4 illustrates raycasting with reference to virtual spatial representation 300, in accordance with some embodiments of the presently disclosed subject matter. A raycast 450 is shown intersecting with virtual display surface 330, and therefore a determination may be made that the user input was indicative of display surface 130.

It will be appreciated that virtual spatial representation 300 may vary depending on the embodiment, and may not necessarily be as depicted in FIGS. 3 and 4. More generally, the virtual model may vary depending on the embodiment.

Referring back to method 200 of FIG. 2, the content item may be interpreted in stage 260 as being selected in any appropriate manner. For example, if a particular display surface 145 (e.g. display surface 130) determined in stage 270, e.g. using the virtual model, is displaying at the time of user input a certain content item, then it may be determined that the user input was indicative of selection of the certain content item. As another example, if a particular display surface 145 is not displaying content at the time in which user input is indicative of the particular display surface 145; and/or if user input is further indicative of a specific content item 120 or of another display surface 145 displaying a given content item, then it may be determined that the user input was indicative of selection of the specific or given content item. The other user display surface 145, in such an example, may be included in the image along with the particular display surface 145, or may be included in a different (e.g. earlier or subsequent) image captured by the camera of portable computer 110 and included in the augmented reality user interface, displayed on touchscreen 115, at an earlier or subsequent time.

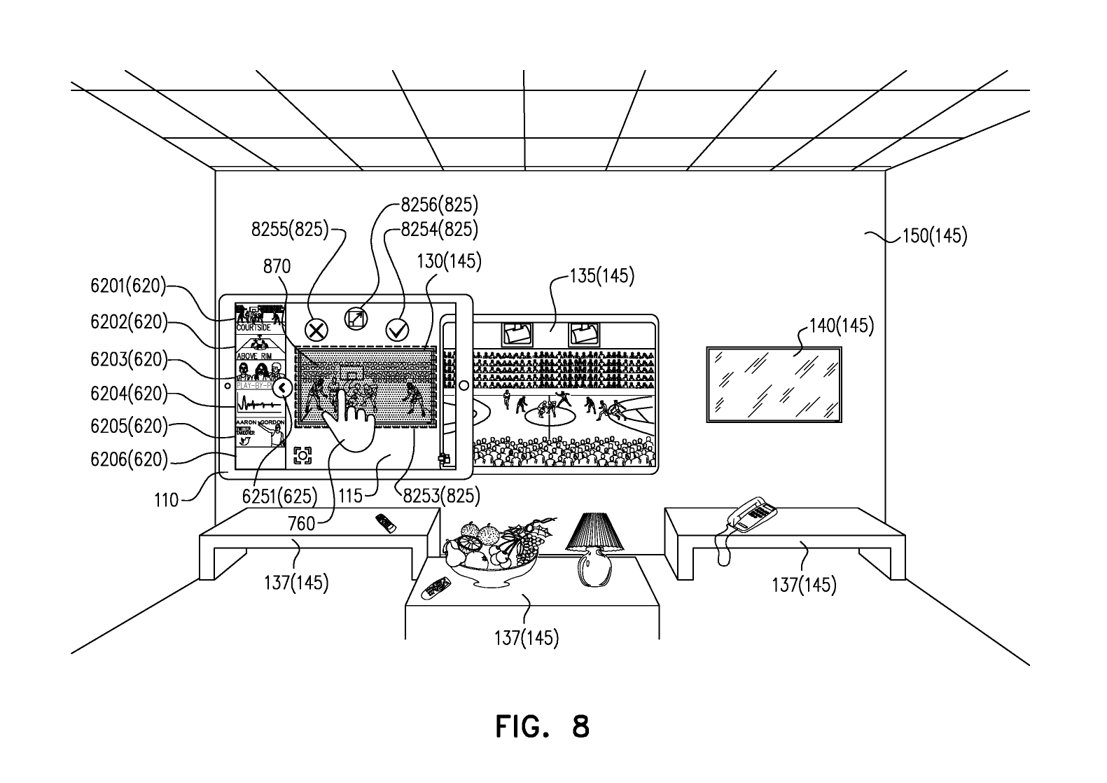

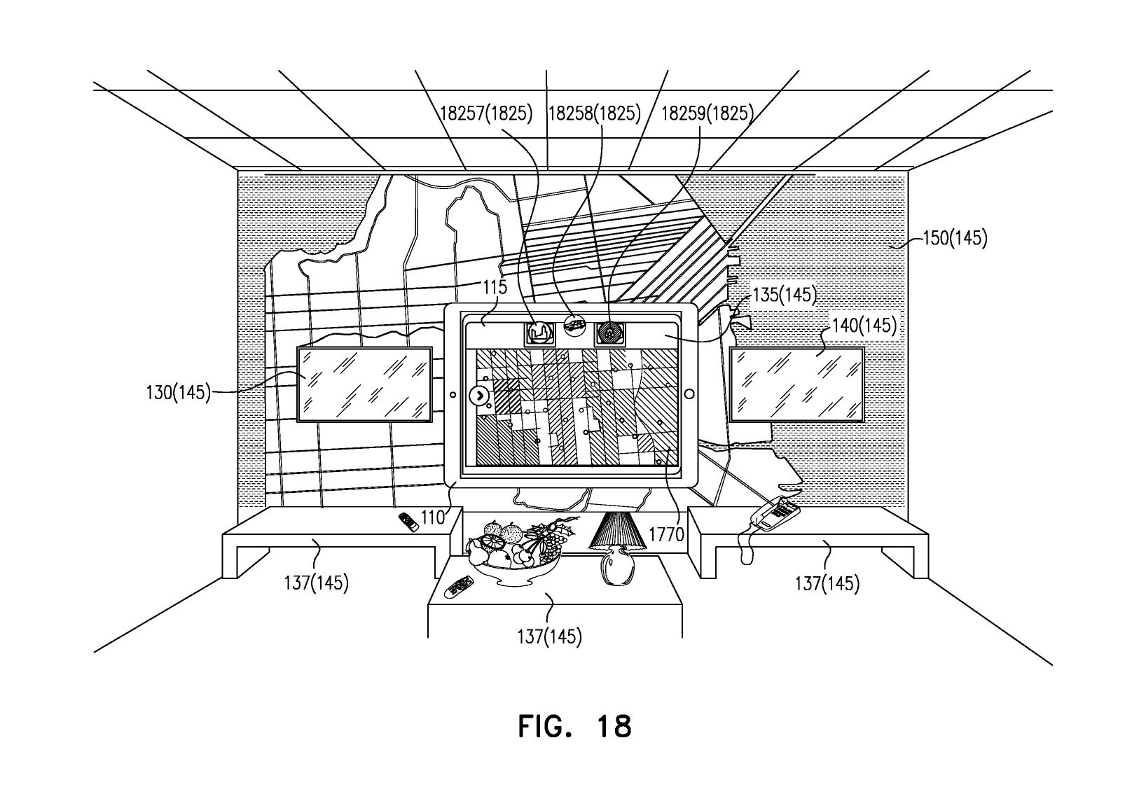

In some embodiments, certain control item(s) 125, such as contextual control items may be invoked, depending on the content item which is interpreted as being selected in stage 260. Such invoked control items 125 may be used for notification to the user (e.g. regarding the content item) and/or for user input. For example, confirmation/non-confirmation control items 125 may be invoked to confirm/not-confirm layout manipulation of the content item (see, for example, description of items 8254 and 8255 with reference to FIG. 8), toggling control items 125 may be invoked to toggle data layers of content (see, for example description of items 18257, 18258 and 18259 with reference to FIG. 18), etc.

In embodiments where the augmented reality user interface is not used, and templates are used instead, stage 230 and stages 250 to 270 may be omitted.

In stage 280 the virtual model may be updated, at any appropriate point in time after the virtual model was constructed, e.g. after performance of stage 240 or 270. For example, if and when the camera physically on portable computer 110 moves in physical environment 100 (FIG. 1), the virtual camera may be moved accordingly in the virtual model. Such a synchronization enables the overlaying of virtual content (what the virtual camera sees) on top of physical content (what the physical camera sees). The synchronization between cameras may be made possible by leveraging an augmented reality platform such as ARKit by Apple®. The augmented reality platform may consider inputs such as the physical camera feed, a gyroscope in portable computer 110, etc. Based on changes in such inputs over time, the augmented reality platform may estimate how much the physical camera has moved and rotated, and such an estimation may be applied to the virtual camera within the virtual model.

In stage 290, content may be caused to be manipulated in physical environment 100. For example, causing the manipulation of content may include causing the manipulation of the layout (or in other words the positioning) of content in accordance with the template interpreted in stage 240 as having been selected. As another example, causing the manipulation of content may include causing the manipulation of a content item interpreted in stage 260 as having been selected using the augmented reality user interface. In the latter example, causing such a manipulation may include causing a content item to move from or to, or causing the content item to be duplicated from or to the display surface determined in stage 270. More broadly, in the latter example, causing the manipulation of the content item may include causing any of the following:

### Layout Manipulation of the Content Item

Mirroring (i.e. duplicating) or transferring (i.e. moving), for example, the content item that is being displayed on touchscreen 115 of portable computer 110 (but is not in an image being captured by the camera of portable computer 110) to a certain display surface 145 that is in the image. In such an example, the content item is one of content item(s) 120 discussed above.
Mirroring or transferring the content item that is being displayed on a specific display surface 145 that is in the image being captured by the camera of portable computer 110, to the touchscreen of portable computer 110, the content item subsequently being displayed on touchscreen 115 even if the camera is no longer capturing the specific display surface 145 in an image (e.g. the content item may be subsequently displayed in a non-augmented reality user interface and/or as one of content items 120).
Mirroring or transferring the content item that is being displayed on one display surface 145 that is in an image being captured by the camera of portable computer 110 to another display surface 145 in the image or in a subsequent image being captured by the camera.
Deleting the content item that is being displayed on a particular display surface 145 that is in the image being captured by the camera of portable computer 110, so that the content item ceases to be displayed on the particular display surface; or deleting the content item that is one of content item(s) 120. For example, one of control item(s) 125 may include an icon for a trash can, and user input may be indicative of removing the content item, e.g. by touching the trash can icon.
Resizing the content item that is being displayed on a particular display surface 145 that is in the image being captured by the camera of portable computer 110; or resizing the content item that is one of content item(s) 120. For example, control item(s) 125 may include icon(s) for resizing, and the user input may be indicative of resizing the content item, e.g. by touching the resizing icon(s).
Etc.

### Non-Layout Manipulation of the Content Item

toggling one or more displaying properties for a content item that is being displayed on a certain display surface 145 that is in the image being captured by the camera of portable computer 110. For example, a displaying property may include a data layer, a number of dimensions, customization for vertical or horizontal displaying, etc.
Etc.

In some embodiments, causing the manipulation of content may include operation(s) such as generation of content rendering instruction(s), provision of the content rendering instruction(s) and/or execution of the content rendering instruction(s). Content rendering instructions are instructions regarding the rendering (e.g. displaying) of content. The content rendering instructions may be executed with respect to the content and with respect to touchscreen 115 and/or display surface(s) 145. It is noted that although the terms moving (transferring), mirroring (duplicating), and deleting are used herein, such terms are used to reflect what appears to be occurring to the user. For example, moving a content item from a source (e.g. touchscreen 115 of portable computer 110 or a first display surface 145) to a destination (e.g. a second display surface 145 or touchscreen 115 of portable computer 110) may be achieved by the usage of content rendering instructions to stop displaying the content item at the source, and begin displaying the content item at the destination, or may be achieved in any other appropriate manner which appears to the user as a transfer of the content item. Deleting a content item, for example, may be achieved by the usage of content rendering instructions to stop displaying the content item at the source, or may be achieved by any other appropriate manner which appears to the user as a deletion of the content item. Whether or not the content item is accessible for display at the source (although not being displayed at the source) after the transfer or deletion may vary depending on the embodiment. Duplicating a content item at a destination, may be achieved, for example, by the usage of content rendering instructions to begin displaying the content item at the destination, or may be achieved in any other appropriate manner which appears to the user as a duplication of the content item. Whether or not the content item was accessible for display at the destination (although not being displayed at the destination) prior to the transfer or duplication may vary depending on the embodiment.

Stage 290 may additionally or alternatively be achieved by bridging user input on portable computer 110 and content manipulation in physical environment 100. Such bridging may rely, for example, on communication protocols such as WebSockets over WiFi. In some embodiments, the bridge between user input and content positioning in physical environment 100 may be achieved by first bridging user input and content arrangement in the virtual model of physical environment 100. The virtual content arrangement may then be reflected (e.g. in real-time) on display surface(s) 145 physically in physical environment 100. For instance, the conversion of user input into suitable content rendering instructions may rely on the virtual model taking into account any of the following: spatial characteristics of the available display surfaces 145 (e.g. absolute positions, dimensions (i.e. sizes), orientations, relative positions, etc.), non-spatial characteristics of the available display surfaces 145 (e.g. resolutions, color profiles, processing powers, networking capabilities, etc.), the position of the user (e.g. by proxy of position of the camera of portable computer 110) relative to such display surfaces 145 in physical environment 100, etc.

In some embodiments, method 200 may include more, fewer, and/or different stages than illustrated in FIG. 2. In some embodiments, the order of stages may differ from the order illustrated in FIG. 2. In some embodiments, stages that are shown in FIG. 2 as being performed sequentially may be performed in parallel.

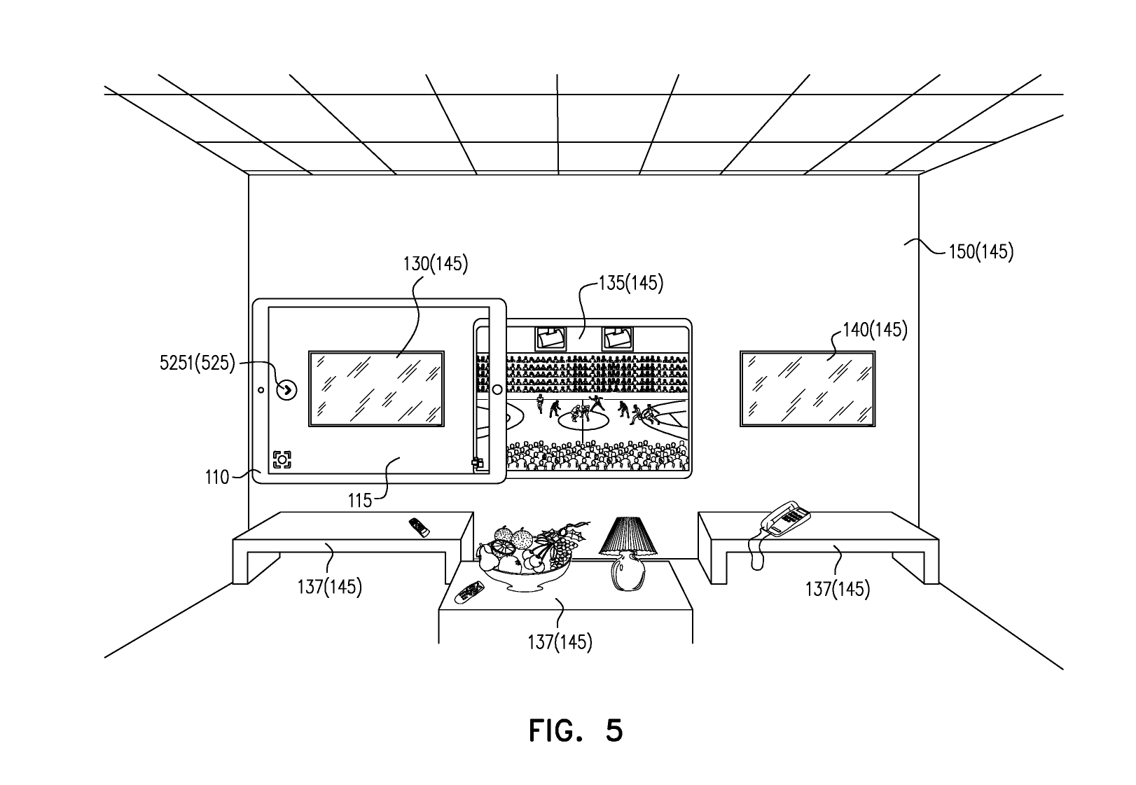

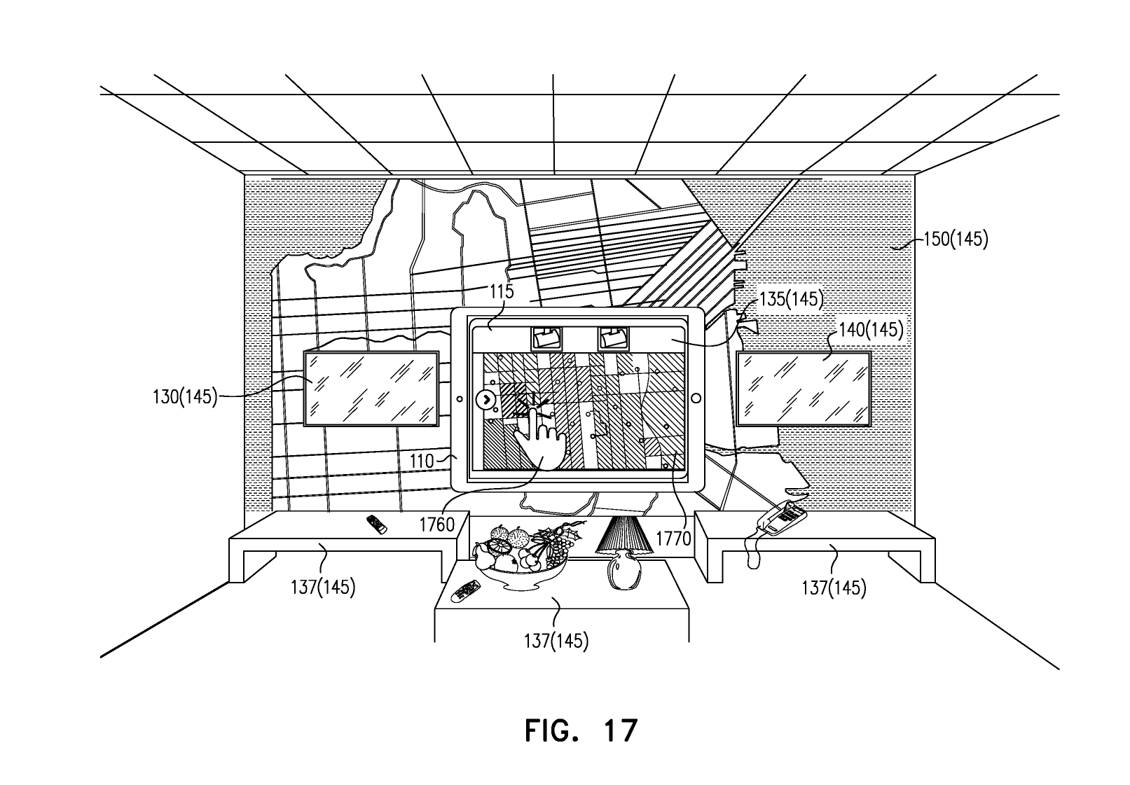

Certain embodiments of any of stages 250, 260, 270 and 290 will now be described with reference to FIGS. 5 to 19. Such embodiments are illustrative of two distinct scenarios: a sports-viewing scenario in a living room scenario, and a smart city scenario in an operational control room scenario. Both scenarios relate to physical environment 100 with display surfaces 145 and portable computer 110, as discussed above with reference to FIG. 1. Although any of FIGS. 5 to 19 may show control items 125 that include placement controls and/or content controls, certain placement controls 125 are emphasized in the description of FIGS. 5 to 16, and certain content controls 125 are emphasized in the description of FIGS. 17 to 19.

FIGS. 5 to 9 illustrate the duplication of content displayed on touchscreen 115 of portable computer 110, to a particular display surface 130, in accordance with some embodiments of the presently disclosed subject matter.

FIG. 5 shows touchscreen 115 of portable computer 110. Displayed on touchscreen 115 is an augmented reality user interface which includes an image, inter-alia of display surface 130, captured by a camera of portable computer 110. The augmented reality user interface on touchscreen 115 also includes control items 525, e.g. more specifically control item 5251. Control items 525 are examples of control items 125 of FIG. 1.

The user may desire to insert a content item onto a particular display surface 145 (e.g. display surface 130) of physical environment 100 (FIG. 1), e.g. by duplicating or transferring the content item from portable computer 110 to display surface 130. The user therefore provides the appropriate user input. For example, the user may swipe to the right, moving control item 5251 to the right of the position shown in FIG. 5. The user input may cause the palette of available content to open.

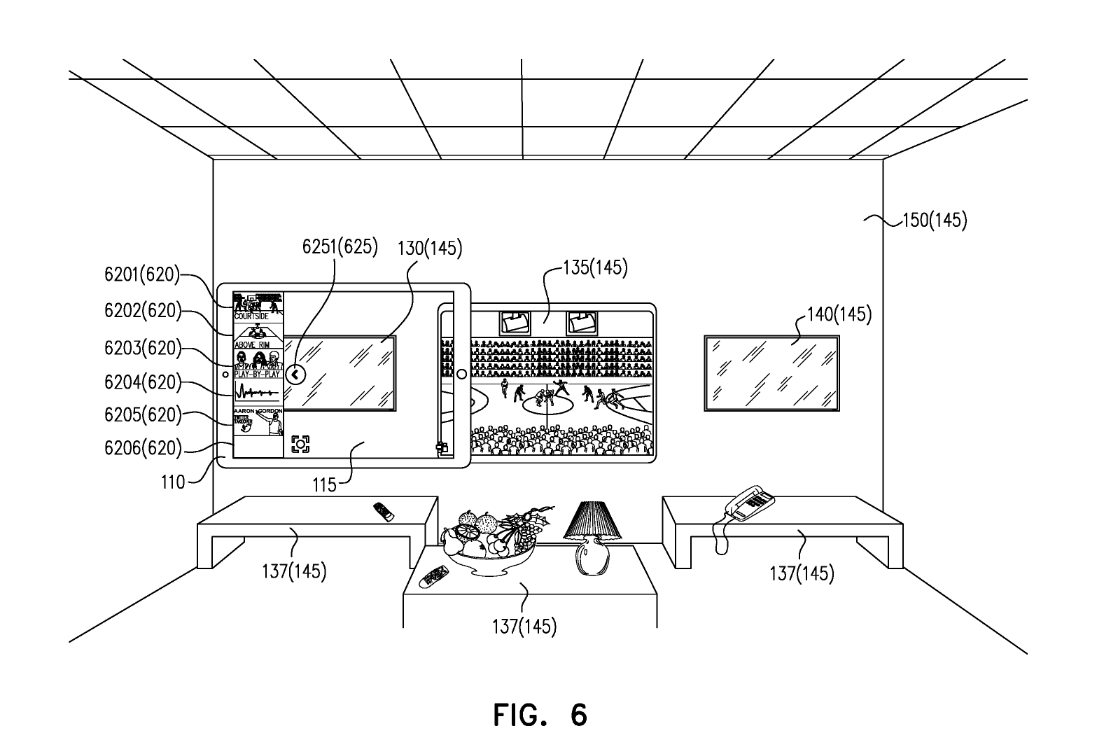

Refer to FIG. 6, which shows touchscreen 115 on portable computer 110. Displayed on touchscreen 115 is an augmented reality user interface which includes the image mentioned in FIG. 5, control items 625, and a palette of content items 620. Control items 625 more specifically includes control item 6251. The position of display of control item 6251 on touchscreen 115 in FIG. 6 is more to the right, than the position of display of control item 5251 on touchscreen 115 in FIG. 5. The palette of available content items 620, includes content items 6201, 6202, 6203, 6204, 6205 and 6206. Content items 620 and control items 625 are examples of content items 120 and control items 125 respectively of FIG. 1.

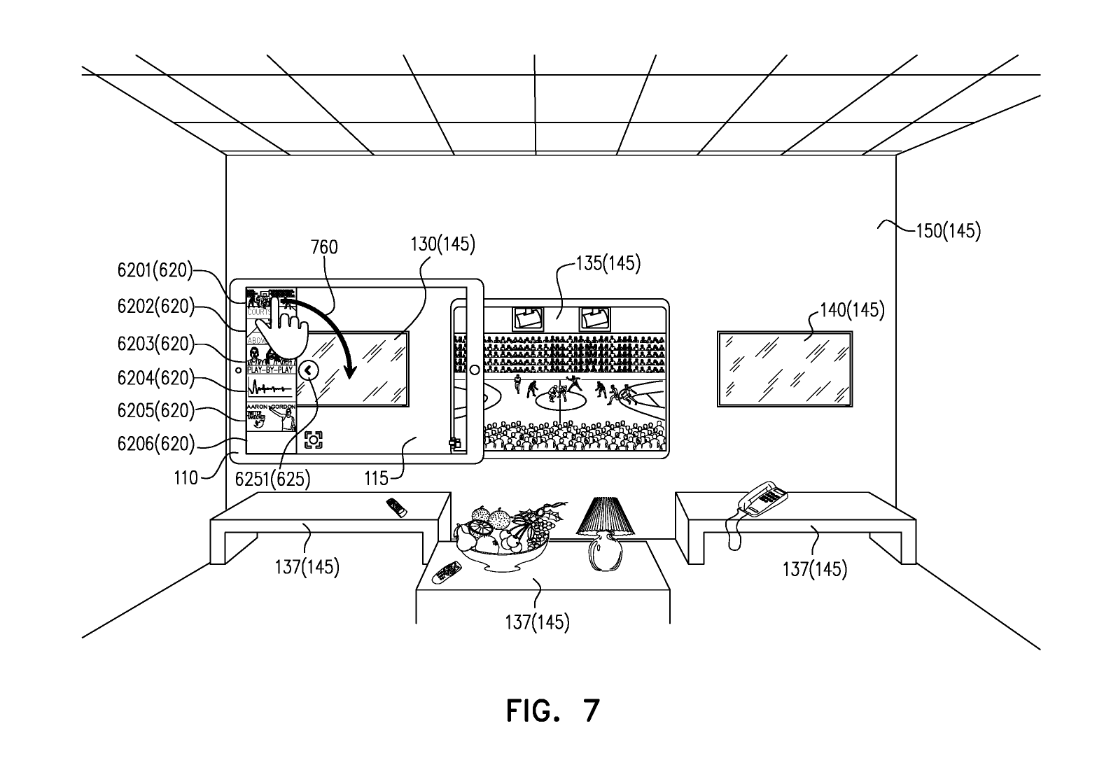

For example, content item 6201 (e.g. relating to a basketball game) that is to be selected by the user (in FIG. 7) is captured at an alternative camera angle (e.g. courtside) from the camera angle used to capture a content item that is being displayed on display surface 135 in physical environment 100.

Referring to FIG. 7, the user may provide appropriate user input to select a particular content item 620 from the palette displayed on touchscreen 115, and a destination display surface 145 (e.g. display surface 130), from the display surface(s) 145 in the image displayed on touchscreen 115. In the example of FIG. 7, the user input includes a drag-and-drop gesture 760 to drag content item 6201 from the palette of content items 620 onto destination display surface 130 in physical environment 100, via augmented reality.

Consequent to drag-and-drop gesture 760 shown in FIG. 7, the selected content item 6201 may be rendered in physical environment 100, e.g. in real-time, on the destination display surface 145 (e.g. display surface 130).

Refer to FIG. 8, which shows drag-and-drop gesture 760 ending on a position in touchscreen 115 where destination display surface 130 is being displayed in an image included in the augmented reality user interface. Therefore, the image being displayed on touchscreen 115 shows content item 870 (which is a duplicate of content item 6201) being displayed on display surface 130, as a consequence of the user input (e.g. including drag-and-drop 760). For example, after being dropped onto display surface 130, content item 870 may remain in placement mode as indicated by a dotted line border 8253 in the augmented reality user interface; and/or content item 870 may be dimmed on display surface 130. Also shown are control items 8254, 8255, and 8256 relating to placement mode, for confirming placement of content item 870, for canceling (or in other words not confirming) placement of content item 870, and for resizing content item 870, respectively. Control items 825 (namely 8253, 8254, 8255, and 8256) are examples of control items 125 of FIG. 1. It is noted that control items 825 do not have counterparts in FIGS. 5 to 7, because such control items 825 are contextual control items which may be invoked in the appropriate context. After the user provides user input, e.g. by tapping control items 8255 or 8254 to cancel placement or confirm placement, placement mode may be exited, thereby removing control items 825.

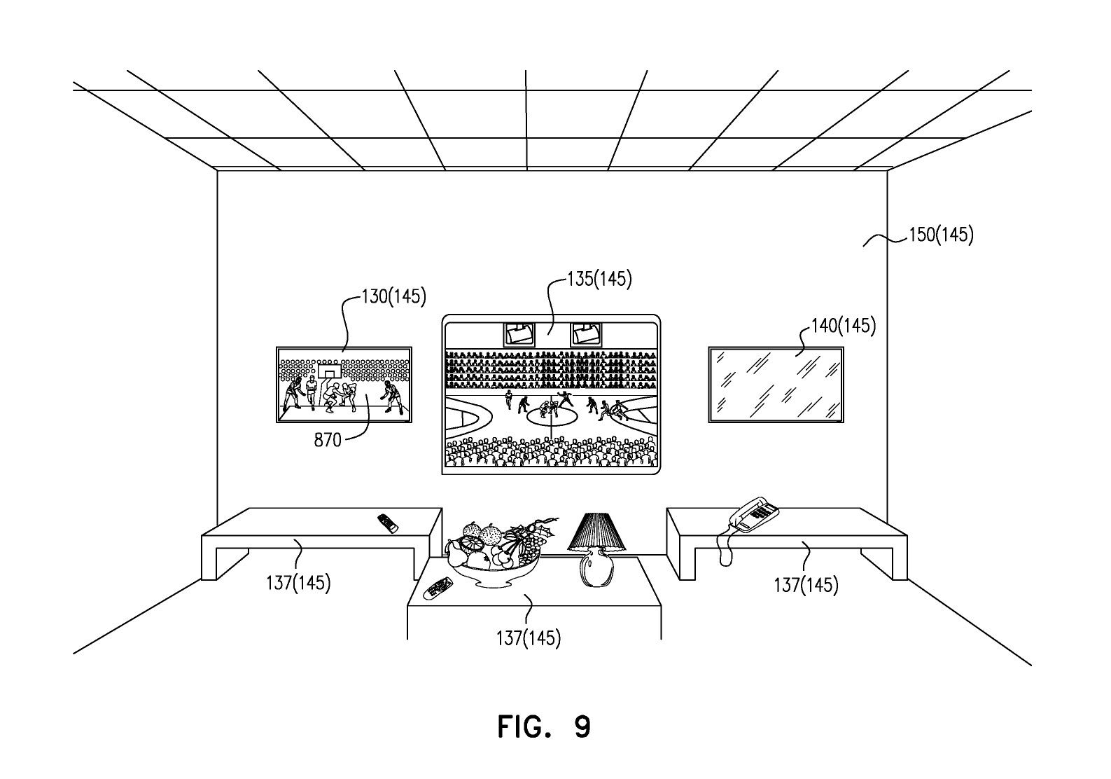

In FIG. 9, content item 870 is shown, displaying on display surface 130, for instance after placement mode was exited for content item 870.

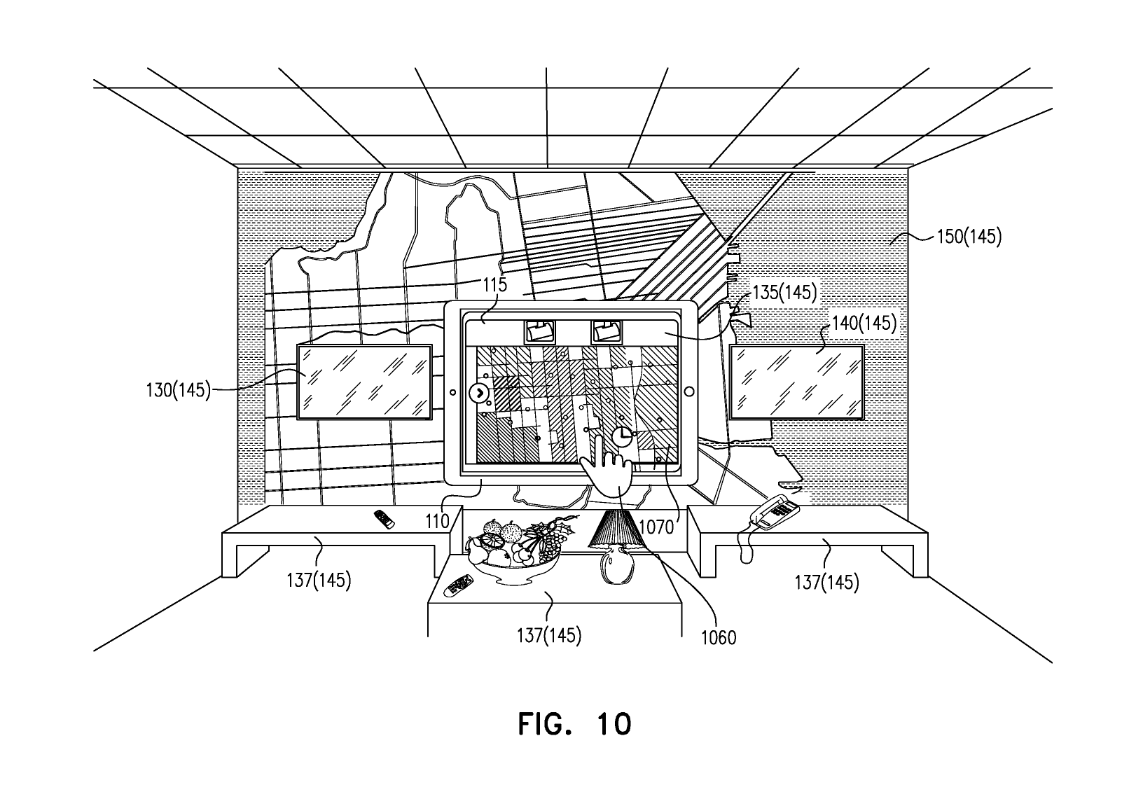

FIGS. 10 to 14 illustrate the moving of content displayed on a particular display surface, to other display surfaces, in accordance with some embodiments of the presently disclosed subject matter.

In FIGS. 10 to 14, a map content item is shown displayed on wall 150. However, since the map content item is displayed on wall 150 in FIGS. 10 to 14, without change, the map content item is not further discussed in the description of FIGS. 10 to 14.

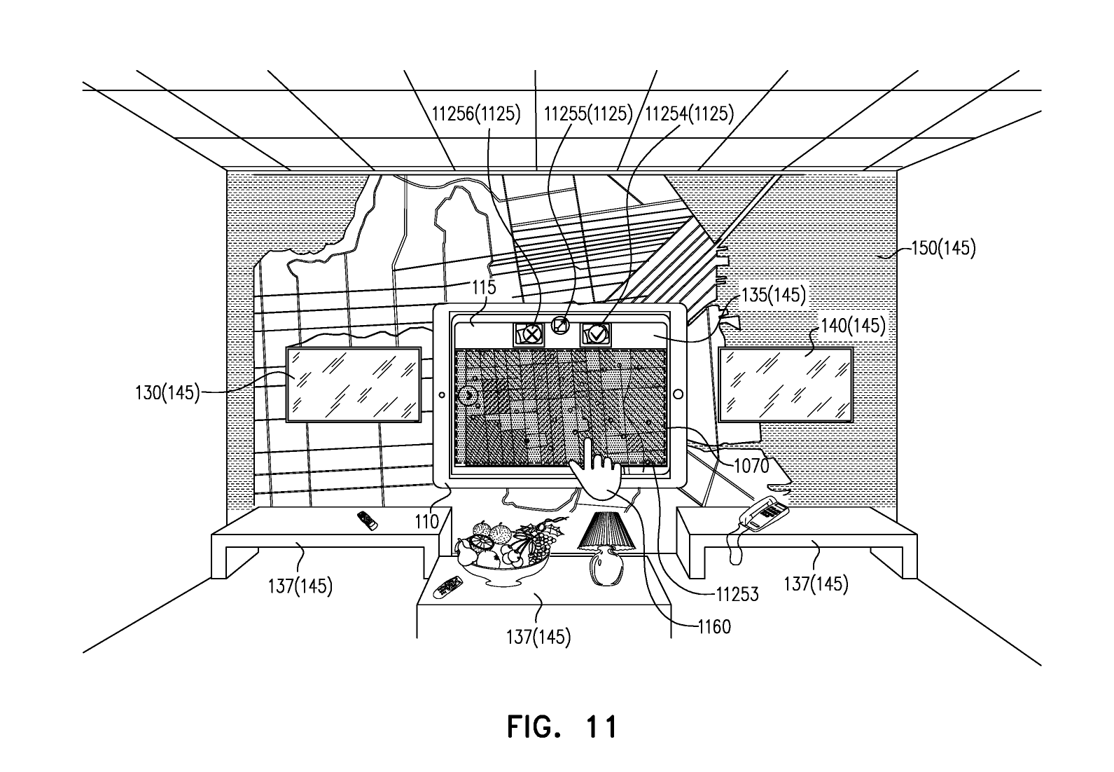

A camera of portable computer 110 captures an image, inter-alia of display surface 135 displaying a content item 1070. In FIG. 10, an augmented reality user interface is displayed on touchscreen 115 of portable computer 110. The augmented reality user interface includes the image captured by the camera. A user provides a user input, e.g. a long-press 1060 (i.e. pressing and holding on for a certain amount of time), on touchscreen 115, at a position where display surface 135 is shown in the image, in order to select content item 1070, displayed on display surface 135, and to select display surface 135 (the source display surface for content item 1070). For example, long-press 1060 may invoke placement mode for content item 1070. While content item 1070 is in placement mode, the user may “touch” content 1070 through the image, and drag content item 1070 from display surface 135 to one or more other display surfaces 145. Synchronously, the layout of the content on display surfaces 145 in physical environment 100 may be manipulated, as will now be explained in more detail with reference to FIGS. 11 to 14.

FIG. 11 shows content item 1070 in placement mode, as indicated by dotted line border control item 11253 displayed on touchscreen 115 of portable computer 110 (and/or by the dimming of content item 1070 on display surface 135). The presence of control items 11254, 11255 and 11256 may additionally or alternatively be indicative of placement mode. Control items 1125 (namely 11253, 11254, 11255, and 11256) may be contextual control items that may be invoked in the appropriate context. Control items 1125 may be examples of control items 125 of FIG. 1. While in placement mode, user input, e.g. drag-and-drop 1160, may be used to move content item 1070 from display surface 135. The beginning of drag-and-drop gesture 1160 is shown in FIG. 11.

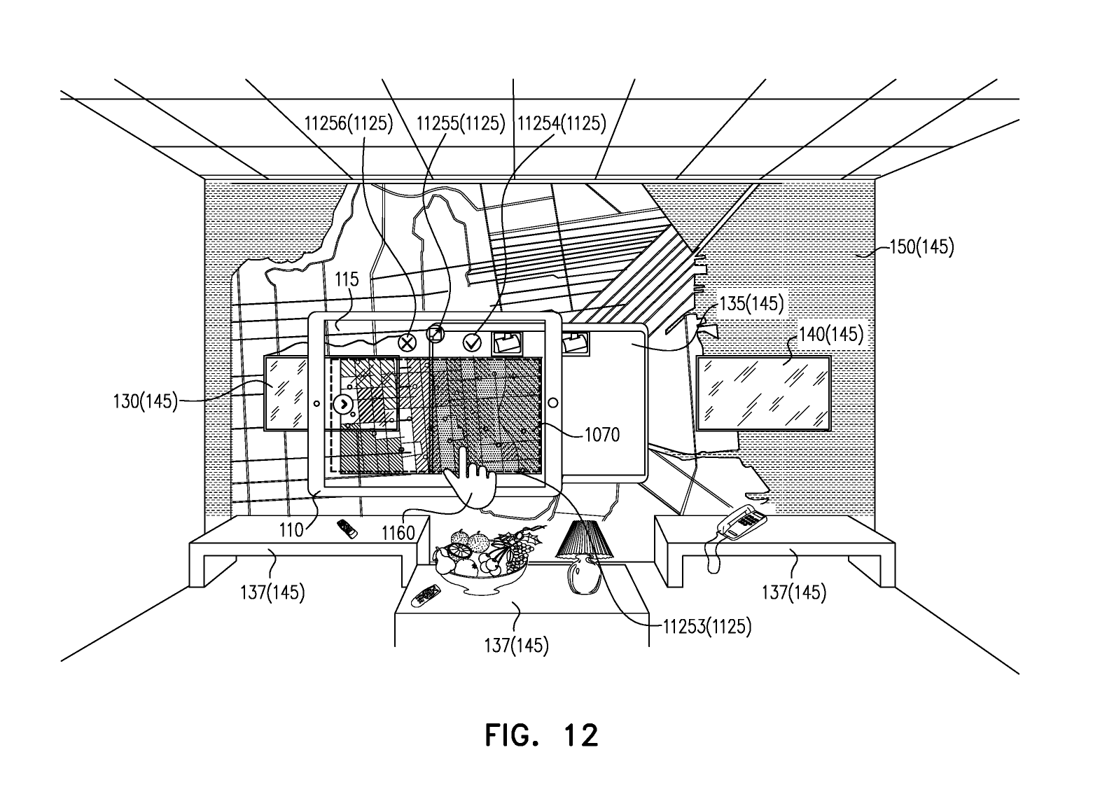

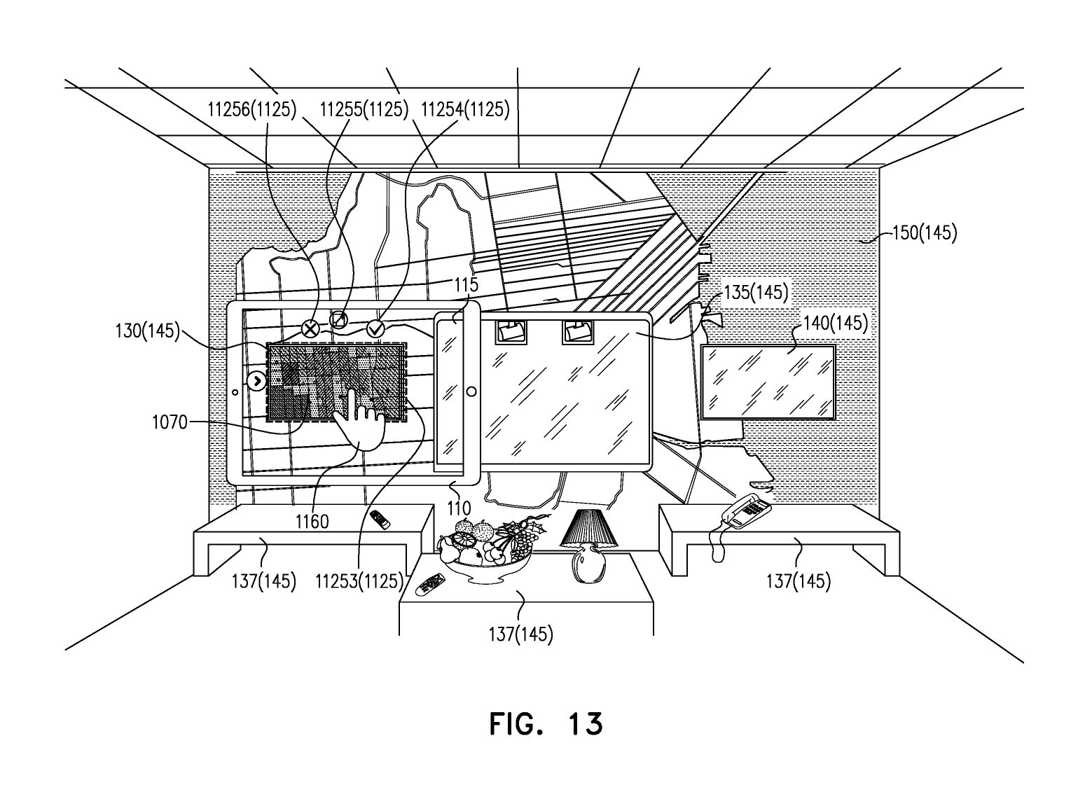

As the field of view of the camera of portable computer 110 changes, the image captured by the camera and displayed on touchscreen 115 of portable computer 110 changes as well. The user input may be interpreted as continuing to include selection of content item 1070, and may be interpreted to further include selection of a destination display surface 145 (e.g. interim destination display surface 145 and/or final destination display surface 145) in the changed image, for content item 1070. FIGS. 12 and 13 are illustrative of such a selection.

Referring to FIG. 12, drag-and-drop 1160 in FIG. 12 is a continuation of drag-and-drop 1160 of FIG. 11. Display surface 130, wall 150, and display surface 135 are partially included in the image captured by the camera of a portable computer 110 and displayed on touchscreen 115 of portable computer 110, after the camera field of view has changed from FIG. 11. User input (e.g. the continuation of drag and drop 1160 on touchscreen 115 of portable computer 110, as shown in FIG. 12) is interpreted to include continued selection of content item 1070; and interpreted to include selection of an interim destination display surface 145 comprising the parts of display surface 130, wall 150, and display surface 135, boxed in by dotted line border 11253. Content item 1070 is therefore shown in FIG. 12 being displayed on interim destination display surface 145, rather than completely on source display surface 135 (as in FIG. 11).

In FIG. 13, the image captured by the camera of portable computer 110 and displayed on touchscreen 115 of portable computer 110 has changed, because the camera field of view has changed from FIG. 12. The image shown in FIG. 13 is inter-alia, of the whole of display surface 130 and the left hand edge of display surface 135. Drag-and-drop 1160 shown in FIG. 13 is the end of drag and drop 1160 begun in FIG. 11. User input, e.g. the ending of drag and drop 1160 on touchscreen 115 of portable computer 110, as shown in FIG. 13, is interpreted to include continued selection of content item 1070 and selection of the final destination display surface 145 (e.g. display surface 130). Content item 1070 is therefore shown in FIG. 13 being displayed on final destination display surface 130, rather than on source display surface 135 (as in FIG. 11). Placement mode may subsequently be exited; (see above discussion with reference to FIG. 8 regarding exiting placement mode).

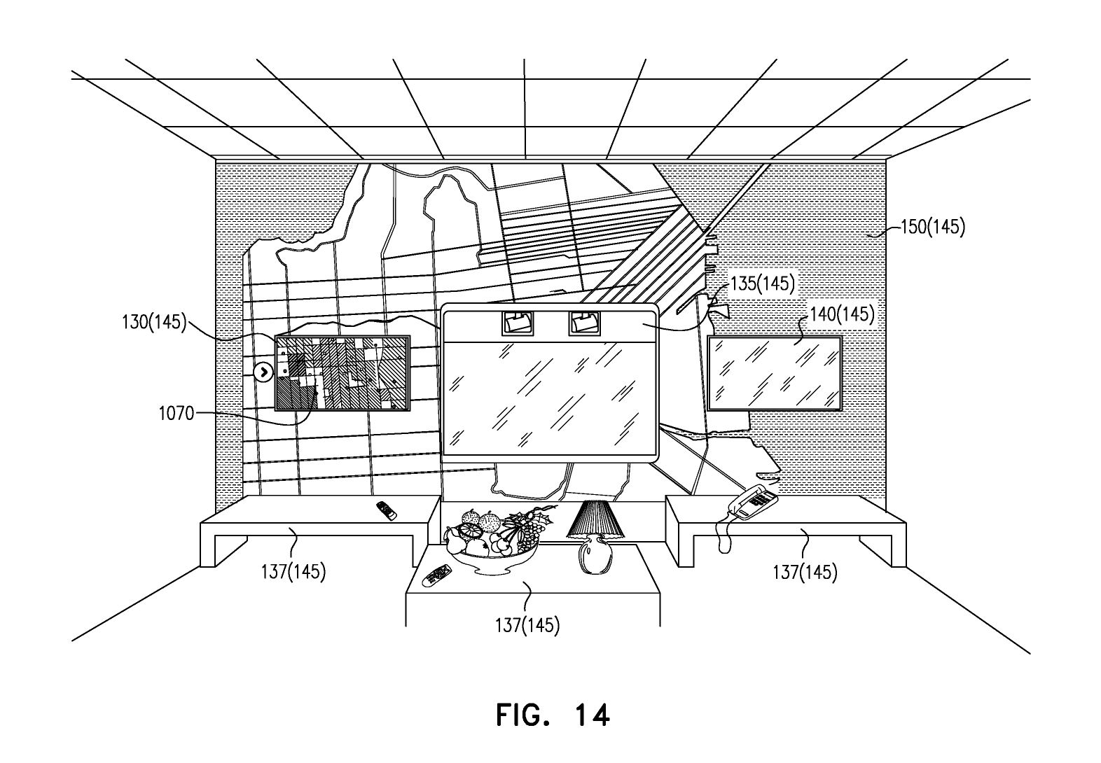

FIG. 14 shows content item 1070 being displayed on display surface 130. Content item 1070 is no longer shown displayed on display surface 135, and therefore has been moved compared to FIG. 10 or 11 where content item 1070 is shown displayed on display surface 135. The series of FIGS. 10 to 14 is therefore illustrative of content item 1070 being moved from display surface 135 to display surface 130.

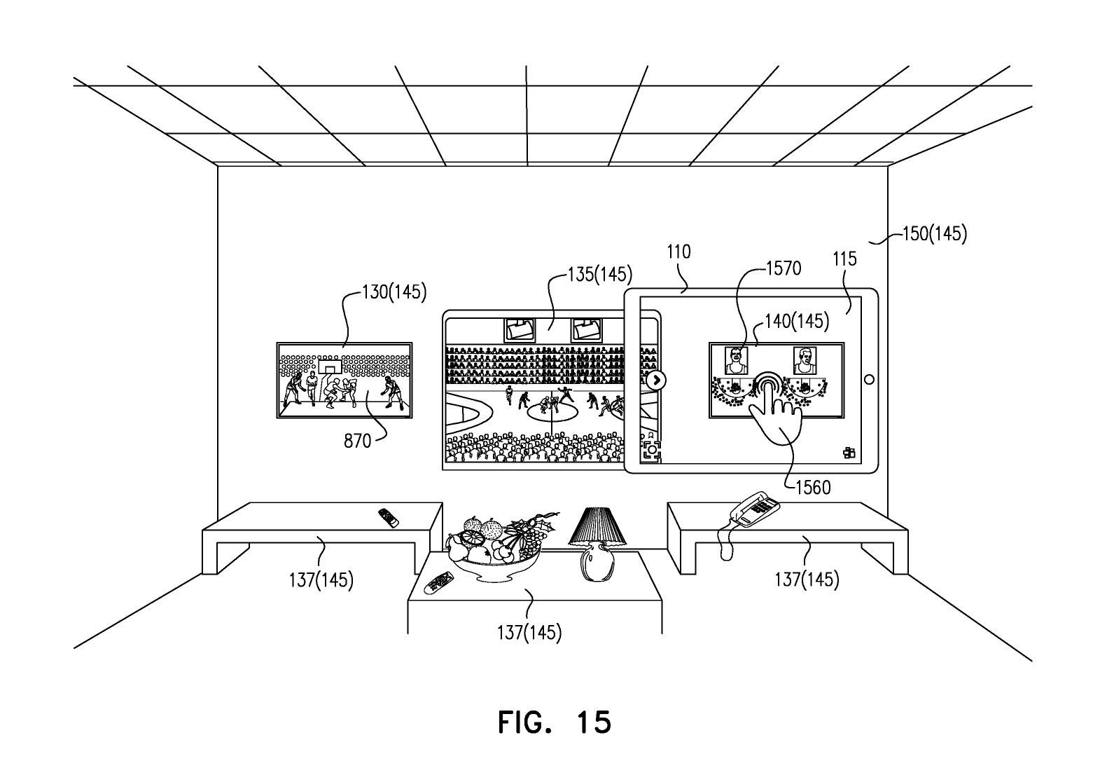

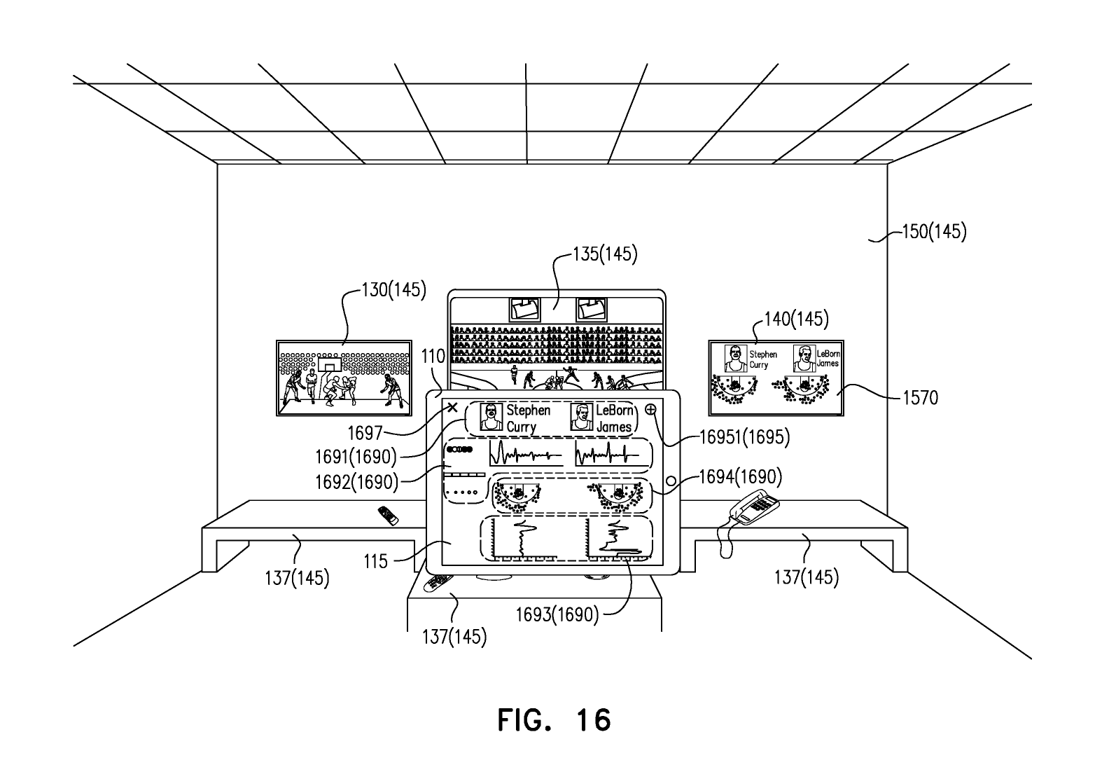

FIGS. 15 and 16 illustrate the duplication of content displayed on a particular display surface 145, to touchscreen 115 of portable computer 110, in accordance with some embodiments of the presently disclosed subject matter.

FIG. 15 shows touchscreen 115 on portable computer 110. Displayed on touchscreen 115 is an augmented reality user interface which includes an image, inter-alia of display surface 140 displaying a content item 1570, captured by a camera of portable computer 110. User input, e.g. a double-tap on touchscreen 115 at a position where content 1570 on display surface 140 is shown in the image, may be interpreted to include selection of content 1570 and of source display surface 140, and to be indicative that content 1570 is to be mirrored on touchscreen 115.

FIG. 16 illustrates a non-augmented reality user interface (e.g. a focused user interface, also referred to herein as zoomed in user interface) on touchscreen 115 of portable computer 110, including content item(s) 1690 and control item(s) 1695, of which one control item 16951 is shown. Content item(s) 1690 includes duplicated content items 1691 and 1694 (duplicating content item 1570 on display surface 140) and additional content items 1692 and 1693. Content item(s) 1690 and control item(s) 1695 may include additional detail and controls which were not relevant given the far distance and lower information density of display surface 140. For instance, when mirroring a sports statistics content view, additional details and information (e.g. content items 1692 and 1693) may be displayed on touchscreen 115, along with control item(s) 1695 to add, remove, and/or change players.

User input by way of control items 1695 may change content items 1690 displayed on touchscreen 115. Optionally such user input may also change content item 1570 displayed on display surface 140 (thereby duplicating content displayed on touchscreen 115 to display surface 140). For example, the user may change the players displayed on touchscreen 115, and the player changes may consequently also be displayed on display surface 140.

Additionally or alternatively, in an augmented reality user interface, an image may be displayed on touchscreen 115. In such a user interface, one or more of content item(s) 1690 and control item(s) that are shown in FIG. 16 may be eliminated and/or may have display size thereof reduced. For example, tapping an “x” 1697 on FIG. 16 may change the user interface displayed on touchscreen 115 from the non-augmented reality user interface shown in FIG. 16 to an augmented reality user interface. Both the non-augmented reality user interface (e.g. focused user interface) and the augmented reality user interface may be part of a user interface of a software application for portable computer 110.

FIGS. 17 to 19 illustrate a toggling of data layers of content, in accordance with some embodiments of the presently disclosed subject matter.

In FIGS. 17 to 19, a map content item is shown displayed on wall 150. However, since the map content item is displayed on wall 150 in FIGS. 17 to 19, without change, the map content item is not further discussed in the description of FIGS. 17 to 19.

FIG. 17 shows touchscreen 115 on portable computer 110. Displayed on touchscreen 115 is an augmented reality user interface which includes an image, inter-alia of display surface 135 displaying a content item 1770, captured by a camera of portable computer 110. Content item 1770 includes a map layer and a data overlay layer. User input (e.g. a tap 1760 on touchscreen 115, at a position where content item 1770 on display surface 135 is shown in the image, the tap occurring when content item 1770 is not in placement mode) may be interpreted to include selection of content item 1770 and display surface 135. In addition, the user input may invoke content control items (see FIG. 18), e.g. that are contextual. For example, if the relationship between content item 1770 and the augmented reality user interface is bi-directional, data containing the content control items may be passed to the augmented reality user interface, in order to be displayed in the augmented reality user interface.

FIG. 18 shows content control items 1825, including content control items 18257, 18258, and 18259 which were invoked by user input 1760 (FIG. 17). Content control items 1825 are included in the augmented reality user interface displayed on touchscreen 115 of a portable computer 110. Content control items 1825 may be examples of control items 125 of FIG. 1. For example, content control items 18257, 18258, and 18259 may be view toggle buttons for switching between different data sets (e.g. crime, traffic, pollution, 3D building extrusions) associated with different overlay layers for content item 1770. The different data sets, for example, may be from different video feeds, or from different data sources. Content control item 18259 is shown shaded, because the currently displayed overlay layer relating to crime for content item 1770, corresponds to content control item 18259. User input by way of a view toggle button, such as tapping on view toggle button 18257 or 18258 may toggle the overlay layer rendered on display surface 135 from the currently displayed overlay layer. For example, content control item 18258 may be tapped.

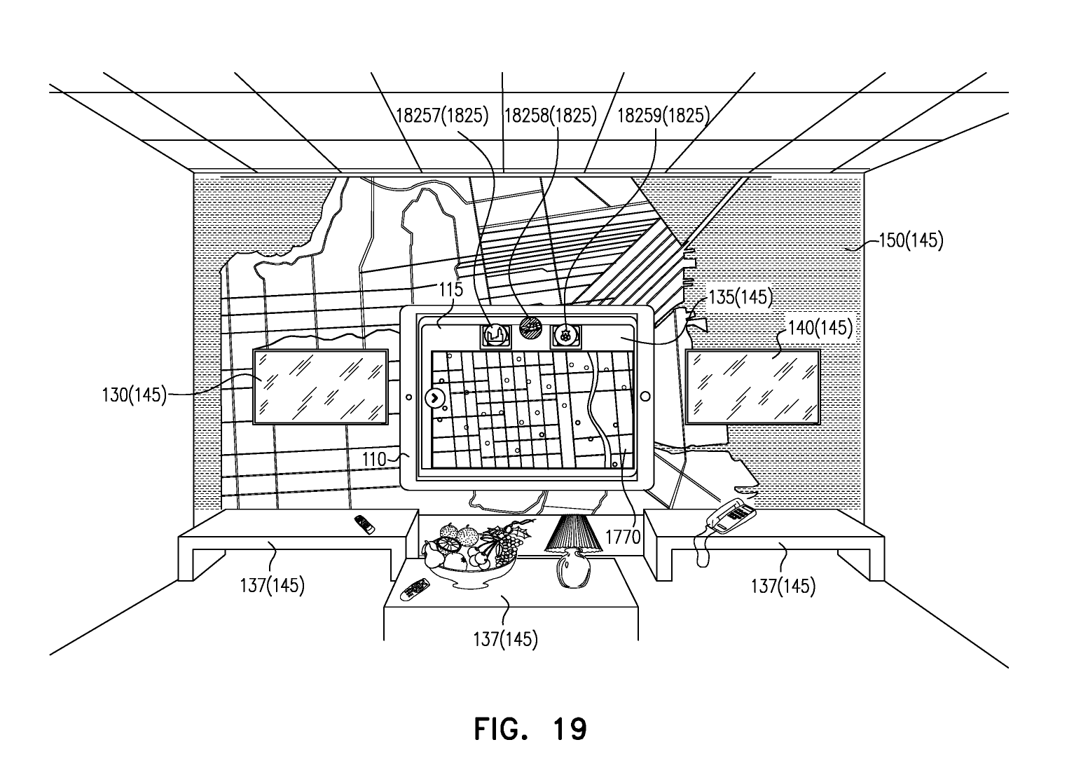

FIG. 19 shows content control items 1825 included in the augmented reality user interface displayed on touchscreen 115 of a portable computer 110. Augmented reality user interface also includes an image, inter-alia of display surface 135 displaying content item 1770, captured by a camera of portable computer 110. Content item 1770, as displayed in FIG. 19, includes a map layer and a data overlay layer regarding traffic. The data overlay layer regarding traffic corresponds to content control item 18258 which was tapped and is accordingly shown shaded in FIG. 19. Due to the user input by way of content control item 18258, the data overlay layer is toggled and therefore the data overlay layer rendered on display surface 135 in FIG. 19 is different from the data overlay layer rendered on display surface 135 in FIGS. 17 and 18.

Additionally or alternatively, due to user input by way of suitable examples of content control items 1825, two dimensional versus three dimensional displaying, displaying suitable for a horizontal display surface 145 (e.g. any of tables 137) versus displaying suitable for a vertical display surface 145 (e.g. wall 150), and/or any other appropriate displaying properties may be toggled for content item 1770.

A discussion of templates now follows. Referring again to stage 230 of method 200 of FIG. 2, user input, such as a tap, may be interpreted as a “yes” in stage 230 to using existing templates, and the user may consequently be provided access to various templates, meaning various arrangements/combinations of complementary content that are suitable for synchronous viewing. The templates may have been defined, for instance, by a content producer and/or provider. A list of the templates may be exposed to the user, e.g. in a template user interface that is separate from an augmented reality user interface, where both may be part of a user interface of a software application for portable computer 110. The list of templates that is exposed to the user may have been filtered automatically by the software application based on the relevancy of available templates defined for the content with respect to the virtual model of physical environment 100.

User input (e.g. a tap on an icon for a given template, included in a template user interface displaying on touchscreen 115 of portable computer 110) may be interpreted as including the selection of the given template in stage 240. The virtual model is optionally updated in stage 280. In stage 290, the positioning (i.e. layout) of content may be caused to be manipulated in physical environment 100 as defined by the given template. For example, the content positioning may be in accordance with the parameters of the virtual model. As part of the template definition, content may have been tagged with metadata such as priority, relationship, and information density. The metadata describing the content may be used as the basis for the content positioning decisions; the feasibility and optimization of positioning may be based on the spatial (e.g. absolute positions, sizes, orientations, relative positions, etc.) and non-spatial (e.g. resolutions, processing powers, color profiles, networking capabilities) characteristics of display surfaces 145, as contained in the virtual model. Using the content layout in the virtual model, the content layout may be reflected, e.g. in real-time, on display surfaces 145 in physical environment 100.

In some embodiments, one of such templates may serve as a starting point for content layout, e.g. prior to performance of stage 220 and possible operations with respect to the augmented reality user interface (e.g. with reference to any of stages 240 to 290).

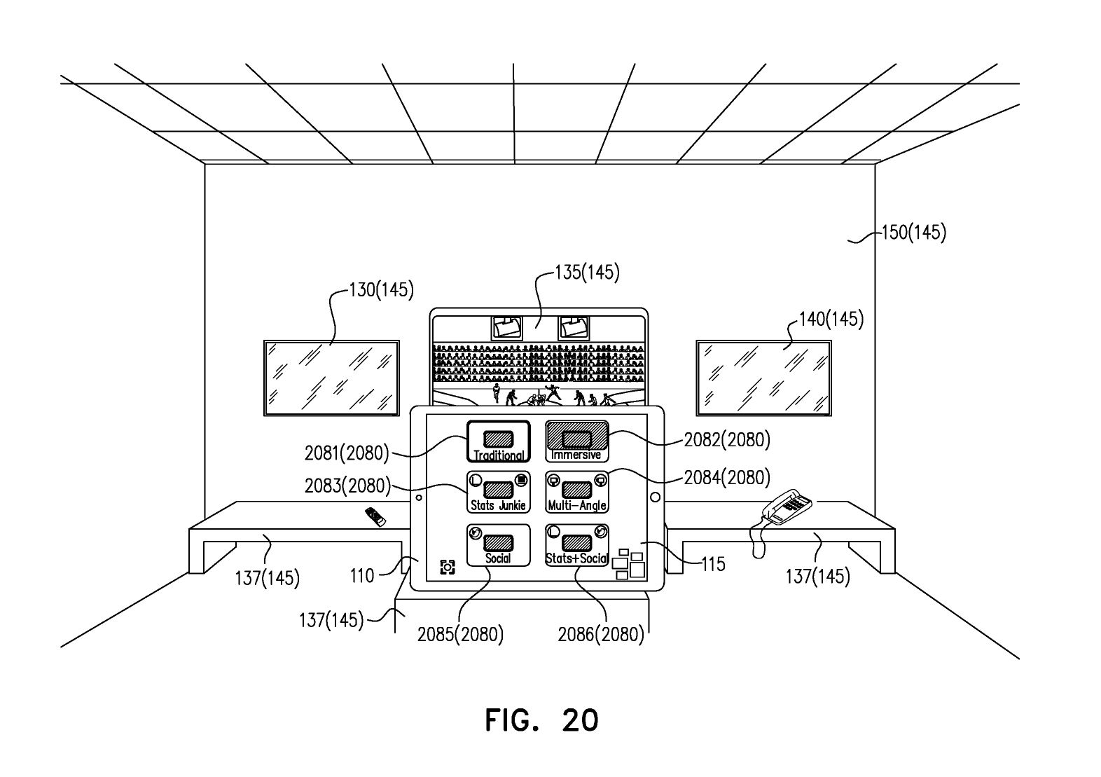

FIGS. 20 to 22 illustrate template selections, in accordance with some embodiments of the presently disclosed subject matters. The effects of the template selections will be described with reference to a sports-viewing scenario in a living room simulation.

In FIG. 20, a template user interface is displayed on touchscreen 115 of portable computer 110. The template user interface includes a list of templates, e.g. more specifically various icons 2080 (including icons 2081, 2082, 2083, 2084, 2085, and 2086) for the templates. Icon 2081 for a traditional template is shown as selected by a black border around icon 2081. Therefore, content is shown displayed on display surface 135, in accordance with the traditional template corresponding to icon 2081.

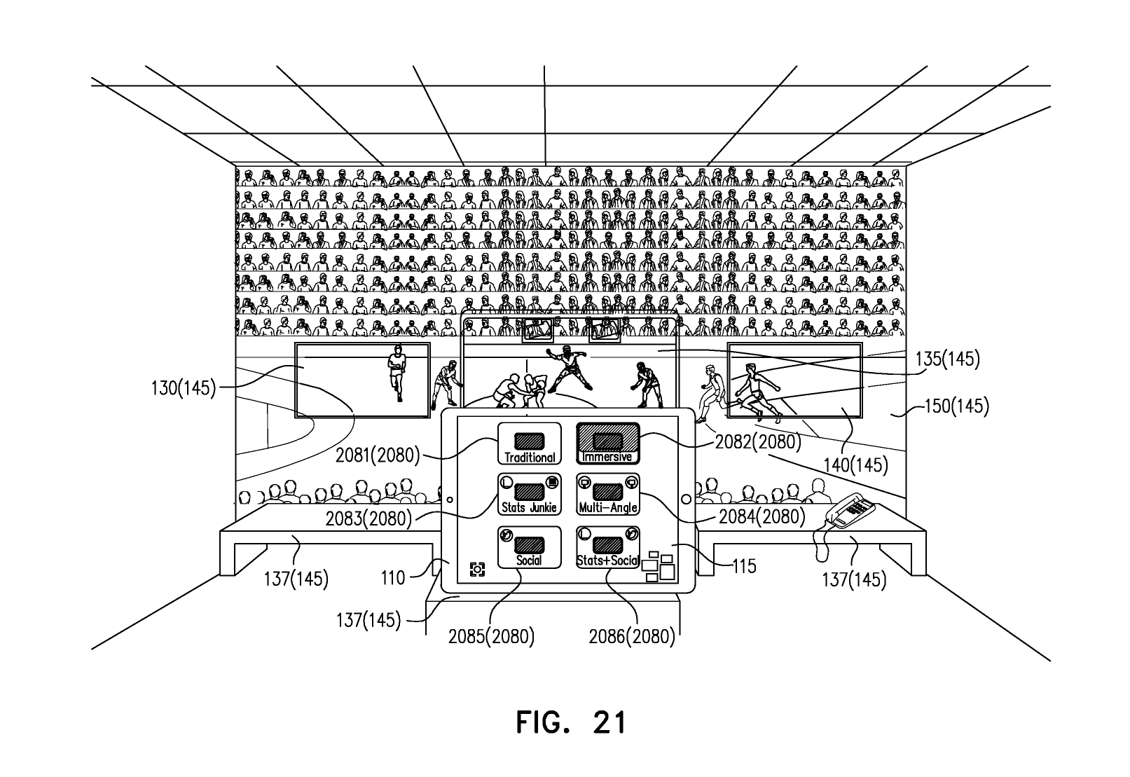

In FIG. 21 the template user interface is displayed on touchscreen 115 of portable computer 110. The template user interface includes a list of templates, e.g. more specifically icons 2080. Icon 2082 for an immersive template is shown as selected by a black border around icon 2082. Therefore, content is displayed on display surfaces 145 including wall 150, display surface 130, display surface 135 and display surface 140, in accordance with the immersive template corresponding to icon 2082.

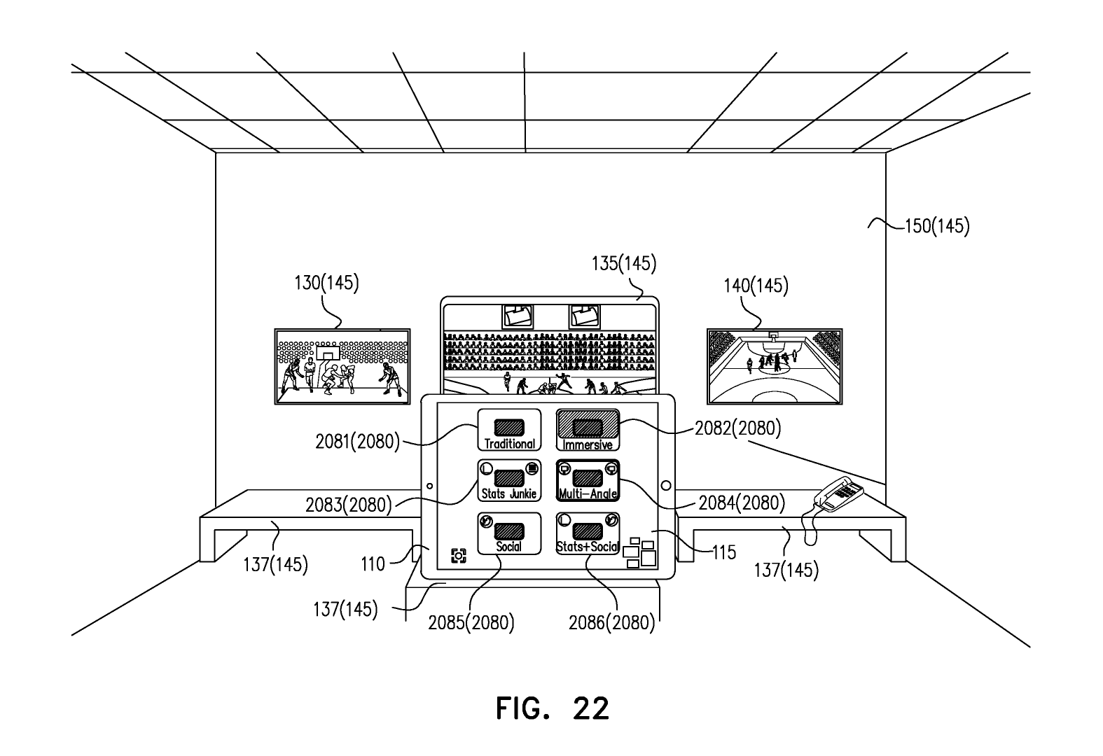

In FIG. 22, the template user interface is displayed on touchscreen 115 of portable computer 110. The template user interface includes a list of templates, e.g. more specifically icons 2080. Icon 2084 for a multi-angle template is shown as selected by a black border around icon 2084. Therefore, content is displayed on display surfaces 130, 135, and 140, in accordance with the multi-angle template corresponding to icon 2084.

Although a shared environment state may be set up in any appropriate manner, for illustrative purposes, some embodiments of setting up a shared environment state will now be presented, with reference to FIGS. 2, 23 and 24.

Referring again to method 200 of FIG. 2, in some embodiments, the setting up the shared environment in stage 210 may include establishing an origin point in stage 202, scanning physical environment 100 in stage 204, and constructing a virtual model in stage 206.

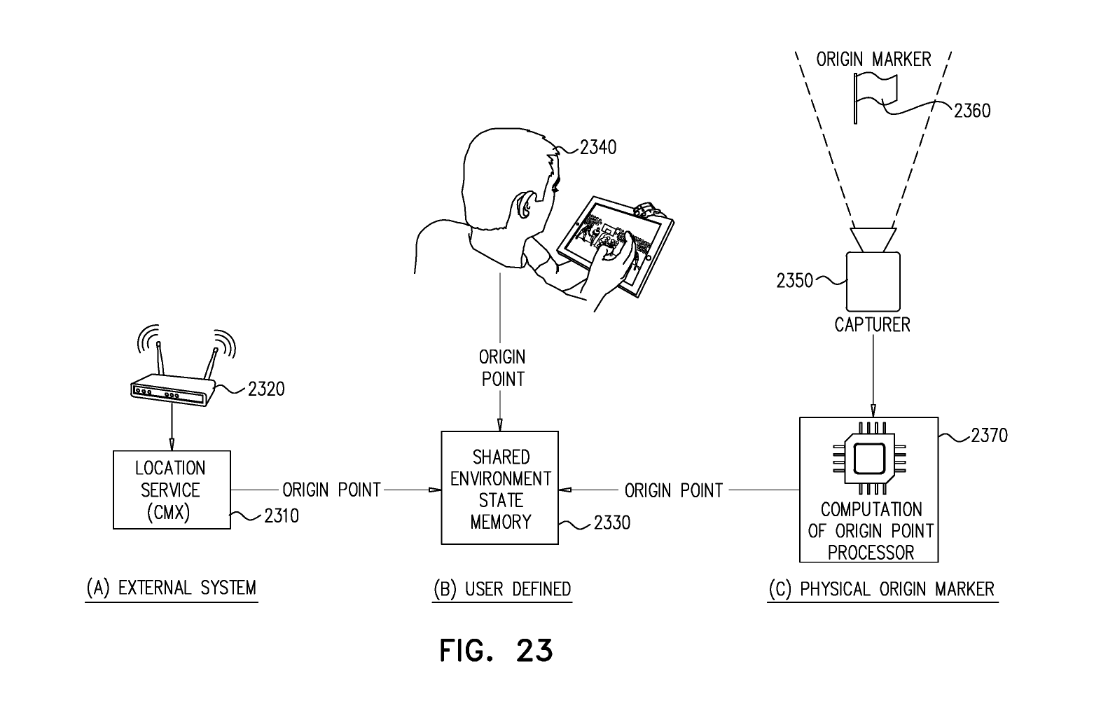

In stage 202 an origin point (0,0,0) may be established to be used to anchor spatial characteristics of physical environment 100 in the virtual model. The origin (0, 0, 0) may be an arbitrary three-dimensional point. The locations of virtual spatial representations of objects in virtual spatial representation 300 (FIG. 3) may be calculated, for example, relative to the origin point, (e.g. with a standard unit of measurement such as 1 meter). FIG. 23 illustrates establishment of an origin point, in accordance with some embodiments of the presently disclosed subject matter. As demonstrated in FIG. 23, the origin point may be established in any of the following ways:
a) External system 2310 (e.g. location service) may establish the origin point (e.g. location of a fixed camera or a Cisco connected mobile experience (CMX) access point 2320). External system 2310 may provide the origin point to a memory 2330 for storing the shared environment state.
b) A user 2340 may manually establish the origin point, either explicitly or via implicit action (e.g. origin point may be at location of portable computer 110 or of another computer upon application launch on portable computer 110 or on the other computer of a software application for scanning physical environment 110). User 2340 may provide the origin point to shared environment state memory 2330.
c) The origin point may be determined during a scan of physical environment 100 in stage 204. For instance a capturer 2350 which performs the scan as part of a manual calibration may capture an origin marker, e.g. an arbitrary pre-determined object 2360 in physical environment 100. A processor 2370 may identify the origin marker and thereby determine the origin point. Processor 2370 may provide the origin point to shared environment state memory 2330.

In stage 204, physical environment 100 may be scanned, in order to determine characteristics of physical environment 100, including physical displays 145. Spatial characteristics of physical environment 100 may be determined, and optionally non-geometric/spatial characteristics of physical environment 100 may be determined. Examples of spatial characteristics for display surface 145 may include absolute positions, sizes, orientations, relative positions, etc. Examples of non-spatial/non-geometric characteristics for display surface 145 may include resolutions, networking capabilities, processing powers, color profiles, etc.

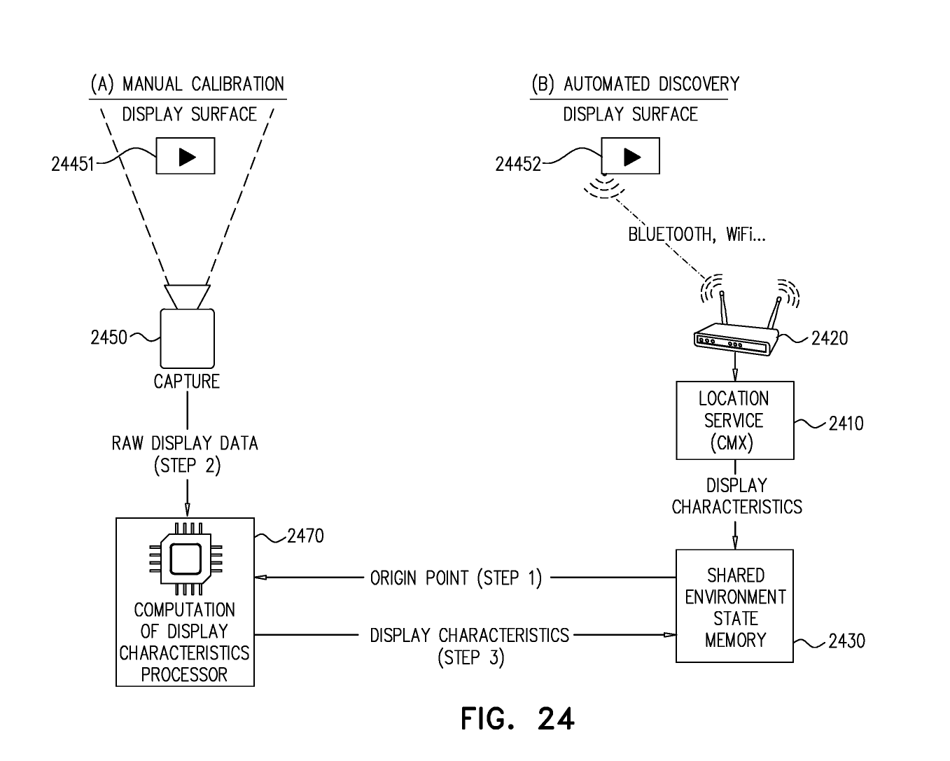

FIG. 24 illustrates the scanning of physical environment 100, in accordance with some embodiments of the presently disclosed subject matter. For example, the scanning of physical environment in stage 204 may be performed via manual calibration and/or automatic network-enabled discovery, as will be described now with reference to FIG. 24:

a) via manual calibration: Memory 2430 for the shared environment state may provide the origin point (if determined in stage 202 of FIG. 2) to a processor 2470. Subsequently, a capturer 2450 may capture raw data including one or more calibration patterns in physical environment 100, e.g. relating to display surfaces 145 such as display surface 24451 in the physical environment. Processor 2470 may recognize the one or more calibration patterns in physical environment 100. Such recognition may be made possible, for example, with computer vision algorithms and libraries (e.g. open source computer vision—OpenCV), which use the captured raw data to compute characteristics of display surfaces 145 such as display surface 24451. The types of capturers which may be used for capturer 2450 and the calibration patterns may vary, depending on the embodiment. A few examples may include:
A Microsoft Kinect, Tango-enabled, or any other infrared camera identifying infrared-reflective markers on the corners of display surfaces 145;
A camera which uses visible light to form an image identifying display patterns rendered on display surfaces 145; or
A Lidar-enabled device for point cloud capture.
   Recognition of the calibration patterns may enable processor 2470 to determine the display surface characteristics. Processor 2470 may provide the determined display surface characteristics to shared environment state memory 2430. Optionally, if the origin point was not determined in stage 202, processor 2470 may recognize the origin point by identifying the pre-determined object used as an origin marker from the raw data.

b) via automated discovery: network-enabled (e.g. WiFi, Bluetooth, etc.) display surfaces 145 such as a display surface 24512 may broadcast the non-spatial capabilities (e.g. resolutions, networking capabilities, processing powers, color profiles, and/or other non-spatial characteristics), dimensions (also referred to herein as sizes), orientations, absolute positions, relative positions, etc., of display surfaces 145 in physical environment 100, through a location service (e.g. a CMX access point 2420 to an external system 2410). For example, display surfaces 145, such as display surface 24512, may be Internet of things (IoT) devices with IoT connectivity. In accordance with automated discovery, processor 2470 (e.g. included in portable computer 110 or in another computer which may or may not also include capturer 2450), knowing the position and orientation thereof in physical environment 100 may infer the positions and orientations of display surfaces 145 relative to processor 2470 using three dimensional math. For example, processor 2470 may be located at the established origin point or may be able to infer the position thereof relative to the established origin point.

c) via a hybrid combination of manual calibration and automated discovery

Stage 204, including scanning of physical environment 100, may be performed once on first run (e.g. in the case of a static physical environment 100), or more than once (e.g. continually) so as to take into account any changes in physical environment 100. If performed more than once, then in subsequent times, an updating of the virtual model in stage 280 may follow.

In stage 206, a virtual model of physical environment 100 may be constructed. The virtual model may include virtual spatial representation 300. Optionally, the virtual model may also include any gathered non-spatial data. The shared environment state may include the virtual model combined with the origin point information.

For example, the information gathered in stage 204 may be used (e.g. by processor 2470) to construct the virtual model. Spatial and optionally non-spatial data regarding physical environment 100, including data regarding display surfaces 145 in physical environment 100, may be used. Standard three-dimensional modeling tools such as Unity® (e.g. executed by processor 2470) may use the gathered spatial data to construct the virtual model of physical environment 100, e.g. including virtual spatial representation 300. A three dimensional engine, such as Unity, may also position the virtual camera within the virtual model, e.g. at the established origin point.

When the virtual model includes non-spatial characteristics in addition to the spatial characteristics of physical environment 100, the spatial and non-spatial characteristics may be stored in a same shared environment state memory or the non-spatial characteristics may be stored and accessible in a complementary storage location to the storage location of the spatial characteristics (e.g. the non-spatial characteristics may be stored in a database in a different shared environment state memory than the shared environment state memory which includes the spatial characteristics).

Depending on the embodiment, location service 2410, memory 2430, capturer 2450, and/or processor 2470 of FIG. 24 may or may not be identical to location service 2310, memory 2330, capturer 2350, and/or processor 2370 of FIG. 23.

In some embodiments, any of stages 202, 204 and 206 may be repeated, if appropriate. For example, any of stages 202, 204 and 206 may be repeated if physical environment 100 has changed due to any of display surfaces 145 having changed. For example, a collection of display surfaces 145 may be changed by adding one or more display surfaces 145, removing one or more display surfaces 145, replacing one or more display surfaces 145, upgrading and/or otherwise changing the spatial and/or non-spatial characteristics of one or more display surfaces 145, etc.

FIG. 25 is a block diagram of a system 2500, in accordance with some embodiments of the presently disclosed subject matter.

System 2500 includes one or more cameras 2510 adapted to capture image(s), where the image(s) may include one or more display surfaces 145. System 2500 further includes one or more touchscreens 2520 adapted to detect user input. System 2500 further includes one or more processors 2530 adapted to display simultaneously on touchscreen(s) 2520 an augmented reality user interface which includes image(s), and includes item(s) not captured by camera(s) 2510. Processor(s) 2530 may include, for example, any of the following: graphics processing unit(s) (GPU(s)), digital signal processor(s) (DSP(s)) central processing units (CPU(s)), etc. Processor(s) 2530 is further adapted to interpret the user input detected by touchscreen(s) 2520 to include selection of an item in the image(s), and a content item; determine that the item in the image(s) is a display surface 145 of the display surface(s) 145 in the image(s); and cause the content item to be moved to, or duplicated to, or moved from, or duplicated from, the display surface 145, and/or cause any other manipulation of the layout of the content item. Processor(s) 2530 is optionally also adapted to interpret user input detected by touchscreen(s) 2520 to include selection of a template and to cause layout of content to be manipulated in accordance with the template. Processor(s) 2530 is optionally also adapted to interpret user input detected by touchscreen(s) 2520 to be indicative of a manipulation not necessarily relating to content layout. For example, the user input may be interpreted as relating to, toggling one or more displaying properties for a content item, etc. Processor(s) 2530 may be adapted to then cause such a manipulation.

System 2500 further includes one or more memories 2540 for storing software which may be executed by processor(s) 2530 in order to perform one or more function(s) described herein, such as displaying a user interface on touchscreen(s) 2520, interpretation of detected user input, determination of a display surface, and causing manipulation of content (e.g. causing moving, duplicating, deleting, positioning in accordance with template, resizing, display property toggling, etc.). Software may include firmware, if appropriate. Memory/ies 2540 may further store data such as the shared environment state, etc. Memory/ies 2450 may include for instance, any of the following: volatile, non-volatile, erasable, non-erasable, removable, non-removable, writeable, re-writeable memory, for short term storing, for long term storing, etc., such as registers, read-only memory (ROM), static random access memory (SRAM), dynamic random access memory (DRAM), flash memory, embedded DRAM, etc.

System 2500 further includes networking circuitry 2550 adapted to communicate with elements external to system 2500. For example, networking circuitry 2550 may be used to communicate with an external system in order to receive or access the shared environment state (e.g. if set up by the external system), or to receive an origin point and/or display surface characteristics (e.g. when setting up the shared environment state). Networking circuitry 2550 may additionally or alternatively be used to communicate with elements external to system 2500, unrelated to the setting up of the shared environment state, e.g. when causing the manipulation of content, when invoking contextual control items, etc. Networking circuitry 2550 may include any appropriate networking circuitry for communication. For instance, networking circuitry 2550 may include antenna(s) and transmitter(s)/receiver(s) for wireless connectivity.

System 2500 optionally also includes additional capturer(s) 2560 in addition to camera(s) 2510, for instance if system 2500 is adapted to set up the shared environment state (stage 210), but scanning of physical environment 100 (e.g. in stage 202 and/or 204) in order to set up the shared environment state is performed by capturer(s) 2560 that are not cameras 2510. In other embodiments, camera(s) 2510 may be adapted to scan in order to set up the shared environment state; or system 2500 may not be adapted to set up the shared environment state, and consequently additional capturer(s) 2560 may be omitted from system 2500.

Depending on the embodiment, system 2500 may perform any of stages 220 to 290. System 2500 or an external system may perform any of stages 202 to 206 of stage 210. If stage 210 is performed by an external system, system 2500 may be adapted to receive or access the shared environment state set up by the external system, e.g. including to receive or access the virtual model, and/or to receive or access origin point data.

In some embodiments, system 2500 may include portable computer 110, whereas in other embodiments system 2500 may include portable computer 110 and other element(s). Portable computer 110 may include camera(s) 2510 and touchscreen(s) 2520. In the former embodiments, processors 2530, memory/ies 2540 and networking circuitry 2550 may also be included in portable computer 110. In the latter embodiments, any of processors 2530, memory/ies 2540 and/or networking circuitry 2550 may be distributed between portable computer 110 and the other element(s), the other element(s) including computer(s). The networking circuitry 2550 in the latter embodiments may be adapted for communication between portable computer 110 and the other element(s), in addition to or instead of being adapted for communication between system 2500 and elements external to system 2500. The other element(s), in the latter embodiments, which may be included in system 2500 may be located in proximity to portable computer 110, or remotely from portable computer 110 (e.g. in a cloud). In the latter embodiments, the functionality of processor(s) 2530 may be distributed in any appropriate manner, in order to enable processor(s) 2530 to collectively perform the functionality. For example, in the latter embodiments, processor(s) 2530 in portable computer 110 may be adapted to display the user interface(s) described herein on touchscreen(s) 2520. In order for processor(s) 2530 in the other element(s) to interpret the user input detected by touchscreen(s) 2520 to include selection of an item in the image(s), and a content item; determine that the item in the image(s) is a display surface 145 in the image(s); and cause the content item to be moved to, or duplicated to, or moved from, or duplicated from, the display surface 145, processor(s) 2530 in portable computer 110 may provide to the processor(s) 2530 in the other element(s), via networking circuitry 2550, an indication of the location(s) on touchscreen(s) 2520 detected as touched by the user. Processor(s) 2530 in the other element(s) may use the indication to interpret the user input to include selection of an item in the image(s) and a content item, determine the display surface in the image(s) and cause the content item to be moved or duplicated. Alternatively for example, in the latter embodiments, processor(s) 2530 in portable computer 110 may interpret the detected user input to include the selection of the content item and may provide to processor(s) 2530 in the other element(s), via networking circuitry 2550, an indication of which content item was selected, and an indication of the location(s) on touchscreen(s) 2520 detected as touched by the user. Processor(s) 2530 in the other element(s) may use the indication to interpret selection of an item in the image(s), determine the display surface in the image(s) and cause the content item to be moved or duplicated.

Advantages of the subject matter may include any of the following. First, users need not independently configure the content on each display surface 145, or rely on proxy control systems such as hardware and software remote controls, unidirectional mirroring (e.g. screen sharing), or rigid video wall management software. Most proxy control systems enable one-to-one interactions between a control device such as portable computer 110 and a particular display surface 145. Selecting a particular display surface 145 in such proxy control systems may include choosing the name/ID of the particular display surface 145 from a list or other abstract representation. Even under proxy control systems where all display surfaces 145 are connected and orchestrated (e.g. video wall), layout controls may remain dedicated to a single static, non-flexible unit (in this case, the single unit is a pre-defined cluster of display surfaces 145). Second, placement control items 125 and content control items 125 may be included in the augmented reality user interface, which has a direct connection to physical environment 100 itself. Therefore, user input with respect to the augmented reality user interface may cause manipulation of content displayed on touchscreen 115 and/or on display surfaces 145. Such an experience may be direct, concrete, and/or substantial for a user. Third, such an experience may result in a greater willingness of a user to adopt technologies such as “connected” collaboration, IoT technology, etc.; and/or such an experience may result in time savings and critical efficiencies, e.g. in professional environments such as enterprise meeting spaces or operational control rooms. For example, IoT connectivity, the scanning of a three dimensional physical environment (e.g. physical environment 100) and subsequent three dimensional virtual spatial representation (e.g. 300) in the virtual model, spatial awareness, wireless connectivity, and augmented reality, may be used to enhance the experience. Other advantages may be apparent from the description herein.

It will be appreciated that the subject matter contemplates, for example, a computer program product comprising a computer readable medium having computer readable program code embodied therein for executing one or more methods disclosed herein; and/or for executing one or more parts of method(s) disclosed herein, e.g. with reference to FIG. 2. Further contemplated, for example, is computer readable program code for executing method(s) disclosed herein; and/or for executing part(s) of method(s) disclosed herein. Further contemplated, for example, is a computer readable medium having computer readable program code embodied therein for executing method(s) disclosed herein; and/or for executing part(s) of method(s) disclosed herein.

In the above description of example embodiments, numerous specific details are set forth in order to provide a thorough understanding of the subject matter. However, it will be appreciated by those skilled in the art that some examples of the subject matter may be practiced without these specific details. In other instances, well-known features have not been described in detail so as not to obscure the subject matter.

It will also be appreciated that various features of the subject matter which are, for clarity, described in the contexts of separate embodiments may also be provided in combination in a single embodiment. Conversely, various features of the subject matter which are, for brevity, described in the context of a single embodiment may also be provided separately or in any suitable subcombination.

It will further be appreciated by persons skilled in the art that the presently disclosed subject matter is not limited by what has been particularly shown and described hereinabove. Rather the scope of the subject matter is defined by the appended claims and equivalents thereof:

What is claimed is:

1. A system comprising:
at least one camera adapted to capture at least one first image including one or more display surfaces;
at least one touchscreen adapted to detect user input; and
at least one processor adapted to:
display, simultaneously on the at least one touchscreen, an augmented reality user interface including:
the at least one first image; and
at least one other item not captured by the at least one camera, the at least one other item including at least one of: one or more control items, or one or more content items;
interpret the user input detected by the at least one touchscreen to include selection of a first item in the at least one first image, and a second content item;
determine that the first item is a first display surface of the one or more display surfaces in the at least one first image; and
cause the second content item to be moved to, or duplicated to, or moved from, or duplicated from, the first display surface.

2. The system of claim 1, wherein the system comprises a portable computer, the portable computer including the at least one camera, the at least one touchscreen, and at least one of the at least one processor.

3. The system of claim 2, wherein the at least one processor includes at least one other processor that is not comprised in the portable computer.

4. The system of claim 1, wherein the at least one camera is adapted to capture at least one second image after capturing the at least one first image, and wherein the second content item is moved from, or duplicated from, the first display surface, and moved to, or duplicated to, a second display surface, the second display surface being included in at least one of: the one or more display surfaces in the at least one first image, or the at least one second image.

5. The system of claim 1, wherein the one or more display surfaces includes a plurality of display surfaces.

6. The system of claim 5, wherein the plurality of display surfaces includes two or more types of display surfaces selected from a group of types comprising: telepresence unit, television, monitor, and projection surface.

7. The system of claim 1, wherein the at least one touchscreen is further adapted to detect further user input, and wherein the at least one processor is further adapted to interpret the further user input to include selection of the first item in the at least one first image, and the second content item; determine that the first item is the first display surface of the one or more display surfaces in the at least one first image; and cause resizing or deletion of the second content item that is being displayed on the first display surface.

8. The system of claim 1, wherein the one or more control items include at least one content control item, wherein the at least one touchscreen is further adapted to detect further user input, and wherein the at least one processor is further adapted to interpret the further user input to include selection of the first item in the at least one first image, and the second content item;
determine that the first item is the first display surface of the one or more display surfaces in the at least one first image; and cause at least one displaying property for displaying the second content item on the first display surface to be toggled.

9. The system of claim 1, wherein the at least one processor being adapted to interpret, includes the at least one processor being adapted to interpret the user input to include selection of the second content item from among the one or more content items, the second content item being moved from, or duplicated from, the at least one touchscreen.

10. The system of claim 1, wherein the at least one processor being adapted to interpret, includes the at least one processor being adapted to interpret the user input to include selection of content that is being displayed on the first display surface, and wherein the second content item is the content that is being displayed on the first display surface.

11. The system of claim 1, wherein the second content item is moved to, or duplicated to, the at least one touchscreen, and wherein the at least one processor is further adapted to display a focused user interface which includes additional content, in addition to the second content item.

12. The system of claim 1, wherein the at least one touchscreen is further adapted to detect further user input, wherein the at least one processor is further adapted to display a template user interface on the at least one touchscreen, the template user interface including a list of templates, to interpret the further user input to include selection of a template from the list, and to cause content to be positioned in accordance with the template.

13. The system of claim 1, wherein the at least one processor being adapted to determine, includes the at least one processor being adapted to determine that a ray representative of the user input, that is sent from at least one virtual camera representing the at least one camera in a virtual model, intersects a virtual display surface representing the first display surface in the virtual model.

14. The system of claim 13, wherein the at least one camera is further adapted to scan a physical environment, and wherein the at least one processor is further adapted to compute characteristics of display surfaces in the physical environment, including the one or more display surfaces, and to construct the virtual model.

15. A method comprising:
displaying simultaneously, on at least one touchscreen, an augmented reality user interface including:
at least one first image captured by at least one camera, the at least one first image including one or more display surfaces; and
at least one other item that was not captured by the at least one camera, the at least one other item including at least one of: one or more control items, or one or more content items;
interpreting user input detected by the at least one touchscreen to include selection of a first item in the at least one first image, and a second content item;
determining that the first item is a first display surface of the one or more display surfaces in the at least one first image; and
causing the second content item to be moved to, or duplicated to, or moved from, or duplicated from, the first display surface.

16. The method of claim 15, wherein the method is performed by a portable computer.

17. The method of claim 15, wherein the second content item is moved from, or duplicated from, the first display surface, and moved to, or duplicated to, a second display surface, the second display surface being included in at least one of: the one or more display surfaces in the at least one first image, or at least one second image captured by the at least one camera after capturing the at least one first image.

18. The method of claim 15, wherein the one or more display surfaces includes a plurality of display surfaces, the plurality of display surfaces including two or more types of display surfaces.

19. The method of claim 15, further comprising:
displaying a template user interface, the template user interface including a list of templates;
detecting further user input;
interpreting the further user input to include selection of a template from the list; and
causing content to be positioned in accordance with the template.

20. A computer program product, comprising a non-transitory computer readable medium having computer readable program code embodied therein, the computer program product comprising:
computer readable program code for causing at least one computer to display simultaneously on at least one touchscreen an augmented reality user interface including: at least one first image captured by at least one camera, the at least one first image including one or more display surfaces; and at least one other item that was not captured by the at least one camera, the at least one other item including at least one of: one or more control items, or one or more content items;
computer readable program code for causing the at least one computer to interpret user input detected by the at least one touchscreen to include selection of a first item in the at least one first image, and a second content item;
computer readable program code for causing the at least one computer to determine that the first item is a first display surface of the one or more display surfaces in the at least one first image; and
computer readable program code for causing the at least one computer to cause the second content item to be moved to, or duplicated to, or moved from, or duplicated from, the first display surface.
